(19) United States
(12) Patent Application Publication
(10) Pub. No.: US 2026/0308333 A1
(43) Pub. Date: Oct. 8, 2026

(54) BLOCK COPOLYMERS WITH POLYESTER MOIETIES AND APPLICATIONS THEREOF

(71) Applicant: ISP INVESTMENTS LLC, Wilmington, DE (US)

(72) Inventors: Osama M. MUSA, Bedminster, NJ (US); Matthew Adam Henry FARMER, Sheffield, South Yorkshire (GB); Steven Peter ARMES, Sheffield, Yorkshire (GB)

(73) Assignee: ISP INVESTMENTS LLC, Wilmington, DE (US)

(21) Appl. No.: 19/490,260

(22) PCT Filed: Jun. 7, 2024
(86) PCT No.: PCT/US2024/033044

§ 371 Date: Dec. 4, 2025

Related U.S. Application Data
(60) Provisional application No. 63/507,007, filed on Jun. 8, 2023.
(60) Provisional application No. 63/583,897, filed on Sep. 20, 2023.

(51) Int. Cl. C08G 81/02; A01N 25/28; A01N 43/54

(52) U.S. Cl. CPC C08G 81/027; A01N 25/28; A01N 43/54

(57) ABSTRACT

The invention provides block copolymers comprising polyester linkages. These copolymers are obtained by the reaction of polyester forming precursors, RAFT agents, and radically polymerizable monomers. The invention further provides compositions comprising the block copolymers and applications thereof in various industrial areas. The invention furthermore provides a method for reducing the particle size of an active ingredient by obtaining a composition that comprises colloidal particles of the block copolymers and the active ingredient and subjecting the composition to a suitable size reduction operation. Each a, b, and R₁₁ is described herein.

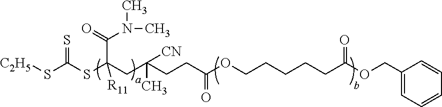

### BACKGROUND

### Field of the Invention

The disclosed and/or claimed inventive concept(s) provides block copolymers having polyester moieties, compositions comprising these polymers, and industrial applications of these compositions.

### Description of Related Art

It is well-known that block copolymers undergo self-assembly both in the solid state and in solution. In the latter case, a diverse range of copolymer morphologies has been reported, including spheres, worms, or vesicles. Typically, the copolymer chains are first prepared in a non-selective solvent and then subjected to either a gradual change in solvency or a pH switch in a separate step, which is typically undertaken in dilute solution.

In recent years, polymerization-induced self-assembly (PISA) of block copolymers in a solvent that is selective for the growing second block has become increasingly popular. PISA offers two decisive advantages over traditional processing methods: (i) syntheses can be conducted at up to 50% w/w solids and (ii) diblock copolymer nanoparticles are obtained directly, without requiring any post-polymerization processing steps. When combined with PISA, controlled radical polymerization techniques such as atom transfer radical polymerization (ATRP) or reversible addition-fragmentation chain transfer (RAFT) polymerization has enabled the preparation of a wide range of well-defined nanoparticles. RAFT dispersion polymerization is known to allow the efficient synthesis of spherical, worm-like or vesicular morphologies in aqueous, alcoholic, or non-polar media as well as ionic liquids.

U.S. published application 2022/0298284 discloses a core-satellite micelle including a core, a shell surrounding the core, and a plurality of satellite domains positioned inside the shell. The core-satellite micelle includes a tetrablock copolymer represented by Structural Formula A1-B1-A2-B2 wherein A1 is a first-monomer first block, B1 is a second-monomer first block, A2 is a first-monomer second block, and B2 is a second-monomer second block. The first-monomer first block A1 and the first-monomer second block A2 may be each independently include any one segment selected from the segment group consisting of a polyvinylpyrrolidone segment, a polylactic acid segment, a polyvinylpyridine segment, a polystyrene segment, a polytrimethylsilylstyrene segment, a C1-C9 polyalkylene oxide segment, a polybutadiene segment, a polyisoprene segment, a polyolefin segment, and a C1-C5 polyalkyl(meth)acrylate segment.

PCT published application 2020/117170 discloses a biosensor comprising a polyphosphonoundecyl acrylate-co-polyvinylimidazole-co-polyvinylferrocene-co-polyglycidyl methacrylate tetra block copolymer as an electron transmitter between the glucose oxidase and redox centre of the electrode for measuring glucose from sweat.

U.S. published application 2005/0256265 discloses an article comprising S1-B1-S2-B2 tetrablock copolymer and at least one other component selected from the group consisting of olefin polymers, styrene polymers, tackifying resins, polymer extending oils and engineering thermoplastic resins, wherein S1, B1, S2, and B2 are polymer blocks, and B1 is a block of polymerized conjugated diene comprising at least 50 mole percent isoprene having an apparent molecular weight of from about 150,000 to about 400,000; S1 and S2 are blocks of polymerized monovinyl aromatic hydrocarbon having a weight average molecular weight of about 12,000 to about 40,000; and B2 is a block of polymerized conjugated diene comprising at least 50 mole percent isoprene having an apparent molecular weight of from about 15,000 to about 60,000.

U.S. Pat. No. 10,905,636 discloses block copolymers comprising repeating units derived from monomers comprising lactam and acryloyl moieties and hydrophobic monomers, compositions, and applications thereof.

U.S. published application 2020/0407470 discloses methods of synthesis of homopolymers and non-homopolymers comprising repeating units derived from monomers comprising lactam and acryloyl moieties in an aqueous medium.

U.S. published application 2019/0382519 discloses cross-linked block copolymers comprising repeating units derived from monomers comprising lactam and acryloyl moieties, compositions, and applications thereof.

U.S. published application 2019/0375875 discloses high molecular weight block copolymers comprising repeating units derived from monomers comprising lactam and acryloyl moieties and hydrophilic monomers, compositions, and applications thereof.

Yu in University of Warwick Ph.D. thesis (2019) describes the crystallization driven self-assembly of polyester based triblock copolymers.

Bromley in University of Surrey Ph.D. thesis (2020) describes the synthesis of triblock copolymers from N-2-hydroxypropyl methacrylamide and homotelechelic caprolactone with terminal RAFT functionalities as therapeutic polymer nanocarriers for drug delivery applications.

Kim, Mays et al. in Polymer (2018), 158: 198-203 describe porous poly(F-caprolactone) microspheres via UV photodegradation of block copolymers prepared by RAFT polymerization.

Bian, Xiao et al. in Journal of Polymer Science Part A Polymer Chemistry (2011), 50: 571-580 describe a RAFT approach for polymerization of N-isopropylacrylamide with a star poly(p-caprolactone) core.

Jeong et al. in ACS Sustainable Chemistry and Engineering (2023), 11 (12), 4871-4884 describe the preparation and pressure-sensitive adhesive and elastomer properties of renewable and degradable triblock copolymers with an ABA-type triblock structure derived from renewable resources.

Ning et al. in Polymers (2018), 10(2), 214 describe the synthesis of well-defined novel, linear, biodegradable, amphiphilic thermo-responsive ABA-type triblock copolymers via a combination of ring-opening polymerization of F-caprolactone and RAFT polymerization of a combination of methacrylate monomers.

It has been found that block copolymers comprising polyester linkages and compositions thereof have unique physicochemical properties such as degradability due to which these copolymers have several applications in the agrochemical, pesticide, pharmaceutical, and biotechnological fields among others.

### SUMMARY

In a first aspect, the disclosed and/or claimed inventive concept(s) provides a polymer having the structure

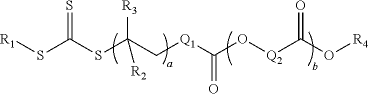

wherein R₄ is a C₁-C₄₀ functionalized or unfunctionalized hydrocarbyl moiety or

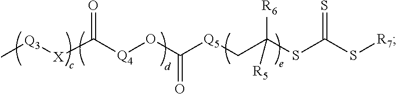

each R₁ and R₇ is independently a C₁-C₁₁ functionalized or unfunctionalized hydrocarbyl moiety; each R₂ and R₅ is independently hydrogen or methyl; each R₃ and R₆ is independently a C₁-C₄₀ functionalized or unfunctionalized hydrocarbyl moiety; each X is independently oxygen or NR₈; each R₈ is independently hydrogen or C₁-C₅ alkyl; each Q₁ and Q₅ is independently a C₁-C₁₀ functionalized or unfunctionalized hydrocarbylene moiety; each Q₂ and Q₄ is independently a C₃-C₈ functionalized or unfunctionalized alkylene moiety; each Q₃ is independently a functionalized or unfunctionalized hydrocarbylene moiety; and each a, b, d, and e independently ranges from about 5 to about 200, and c ranges from 1 to about 100.

In a second aspect, the disclosed and/or claimed inventive concept(s) provides a composition comprising a polymer having the structure

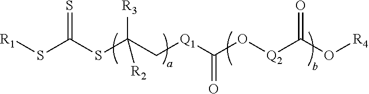

wherein R₄ is a C₁-C₄₀ functionalized or unfunctionalized hydrocarbyl moiety or

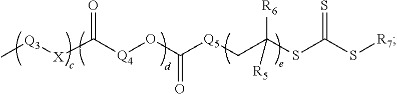

each R₁ and R₇ is independently a C₁-C₁₁ functionalized or unfunctionalized hydrocarbyl moiety; each R₂ and R₅ is independently hydrogen or methyl; each R₃ and R₆ is independently a C₁-C₄₀ functionalized or unfunctionalized hydrocarbyl moiety; each X is independently oxygen or NR₈; each R₈ is independently hydrogen or C₁-C₅ alkyl; each Q₁ and Q₅ is independently a C₁-C₁₀ functionalized or unfunctionalized hydrocarbylene moiety; each Q₂ and Q₄ is independently a C₃-C₈ functionalized or unfunctionalized alkylene moiety; each Q₃ is independently a functionalized or unfunctionalized hydrocarbylene moiety; and each a, b, d, and e independently ranges from about 5 to about 200, and c ranges from 1 to about 100.

In a third aspect, the disclosed and/or claimed inventive concept(s) provides a method for reducing particle size of at least one active ingredient comprising: (a) contacting to form a mixture, the active ingredient in a solid form and a colloidal composition comprising a polymer having the structure

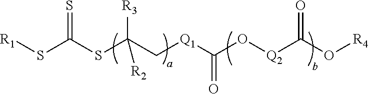

wherein R₄ is a C₁-C₄₀ functionalized or unfunctionalized hydrocarbyl moiety or

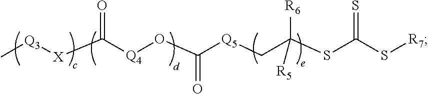

each R₁ and R₇ is independently a C₁-C₁₁ functionalized or unfunctionalized hydrocarbyl moiety; each R₂ and R₅ is independently hydrogen or methyl; each R₃ and R₆ is independently a C₁-C₄₀ functionalized or unfunctionalized hydrocarbyl moiety; each X is independently oxygen or NR₈; each R₈ is independently hydrogen or C₁-C₅ alkyl; each Q₁ and Q₅ is independently a C₁-C₁₀ functionalized or unfunctionalized hydrocarbylene moiety; each Q₂ and Q₄ is independently a C₃-C₈ functionalized or unfunctionalized alkylene moiety; each Q₃ is independently a functionalized or unfunctionalized hydrocarbylene moiety; and each a, b, d, and e independently ranges from about 5 to about 200, and c ranges from 1 to about 100; and (b) subjecting the mixture to at least one particle size reduction operation.

### DETAILED DESCRIPTION

Before explaining at least one aspect of the disclosed and/or claimed inventive concept(s) in detail, it is to be understood that the disclosed and/or claimed inventive concept(s) is not limited in its application to the details of construction and the arrangement of the components or steps or methodologies set forth in the following description or illustrated in the drawings. The disclosed and/or claimed inventive concept(s) is capable of other aspects or of being practiced or carried out in various ways. Also, it is to be understood that the phraseology and terminology employed herein is for the purpose of description and should not be regarded as limiting.

Unless otherwise defined herein, technical terms used in connection with the disclosed and/or claimed inventive concept(s) shall have the meanings that are commonly understood by those of ordinary skill in the art. Further, unless otherwise required by context, singular terms shall include pluralities and plural terms shall include the singular.

All patents, published patent applications, and non-patent publications referenced in any portion of this application are herein expressly incorporated by reference in their entirety to the same extent as if each individual patent or publication was specifically and individually indicated to be incorporated by reference.

All articles and/or methods disclosed herein can be made and executed without undue experimentation based on the present disclosure. While the articles and methods of the disclosed and/or claimed inventive concept(s) have been described in terms of aspects, it will be apparent to those of ordinary skill in the art that variations may be applied to the articles and/or methods and in the steps or in the sequence of steps of the method described herein without departing from the concept, spirit and scope of the disclosed and/or claimed inventive concept(s). All such similar substitutes and modifications apparent to those skilled in the art are deemed to be within the spirit, scope, and concept of the disclosed and/or claimed inventive concept(s).

As utilized in accordance with the disclosure, the following terms, unless otherwise indicated, shall be understood to have the following meanings.

The use of the word “a” or “an” when used in conjunction with the term “comprising” may mean “one,” but it is also consistent with the meaning of “one or more,” “at least one,” and “one or more than one.” The use of the term “or” is used to mean “and/or” unless explicitly indicated to refer to alternatives only if the alternatives are mutually exclusive, although the disclosure supports a definition that refers to only alternatives and “and/or.”

Throughout this application, the term “about” is used to indicate that a value includes the inherent variation of error for the quantifying device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent.

The use of the term “at least one” will be understood to include one as well as any quantity more than one, including but not limited to, 1, 2, 3, 4, 5, 10, 15, 20, 30, 40, 50, 100, etc. The term “at least one” may extend up to 100 or 1000 or more depending on the term to which it is attached.

In addition, the quantities of 100/1000 are not to be considered limiting as lower or higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first”, “second”, “third”, “fourth”, etc.) is solely for the purpose of differentiating between two or more items and, unless otherwise stated, is not meant to imply any sequence or order or importance to one item over another or any order of addition.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. The term “or combinations thereof” as used herein refers to all permutations and combinations of the listed items preceding the term. For example, “A, B_{Xn}, B_{Xn+1}, or combinations thereof” is intended to include at least one of: A, B_{Xn}, B_{Xn+1}, AB_{Xn}, A B_{Xn+1}, B_{Xn}B_{Xn+1}, or AB_{Xn}B_{Xn+1} and, if order is important in a particular context, also B_{Xn}A, B_{Xn+1}A, B_{Xn+1}B_{Xn}, B_{Xn+1}B_{Xn}A, B_{Xn}B_{Xn+1}A, AB_{Xn+1}B_{Xn}, B_{Xn}AB_{Xn+1}, or B_{Xn+1}AB_{Xn}. Continuing with this example, expressly included are combinations that contain repeats of one or more item or term, such as B_{Xn}B_{Xn}, AAA, MB_{Xn}, B_{Xn}B_{Xn}B_{Xn+1}, AAAB_{Xn}B_{Xn+1}B_{Xn+1}B_{Xn+1}B_{Xn+1}, B_{Xn+1}B_{Xn}B_{Xn}AAA, B_{Xn+1}A B_{Xn}AB_{Xn}B_{Xn}, and so forth. The skilled artisan will understand that typically there is no limit on the number of items or terms in any combination, unless otherwise apparent from the context.

The term “each independently selected from the group consisting of” means when a group appears more than once in a structure, that group may be selected independently each time it appears.

The term “hydrocarbyl” includes straight-chain and branched-chain alkyl, alkenyl, alkynyl, cycloalkyl, cycloalkenyl, aryl groups, and combinations thereof with optional heteroatom(s). A hydrocarbyl group may be mono-, di- or polyvalent.

The term “alkyl” refers to a functionalized or unfunctionalized, monovalent, straight-chain, branched-chain, or cyclic hydrocarbyl group optionally having one or more heteroatoms.

Non-limiting examples of alkyl include methyl, ethyl, n-propyl, isopropyl, n-butyl, isobutyl, tert-butyl, n-pentyl, isopentyl, n-hexyl, n-heptyl, n-octyl, 2-ethylhexyl, tert-octyl, iso-norbornyl, n-dodecyl, tert-dodecyl, n-tetradecyl, n-hexadecyl, n-octadecyl, n-eicosyl, cyclobutyl, cyclopentyl, cyclohexyl, and the like. The definition of “alkyl” also includes groups obtained by combinations of straight-chain, branched-chain and/or cyclic structures.

The term “aryl” refers to a functionalized or unfunctionalized, monovalent, aromatic hydrocarbyl group optionally having one or more heteroatoms. The definition of aryl includes carbocyclic and heterocyclic aromatic groups. Non-limiting examples of aryl groups include phenyl, naphthyl, indenyl, indanyl, azulenyl, fluorenyl, anthracenyl, furyl, thienyl, pyridyl, pyrrolyl, oxazolyl, thiazolyl, imidazolyl, pyrazolyl, 2-pyrazolinyl, pyrazolidinyl, isoxazolyl, isothiazolyl, 1,2,3-oxadiazolyl, 1,2,3-triazolyl, 1,3,4-thiadiazolyl, pyridazinyl, pyrimidinyl, pyrazinyl, 1,3,5-triazinyl, 1,3,5-trithianyl, indolizinyl, indolyl, isoindolyl, 3H-indolyl, indolinyl, benzo[b]furanyl, 2,3-dihydrobenzofuranyl, benzo[b]thiophenyl, 1H-indazolyl, benzimidazolyl, benzthiazolyl, purinyl, 4H-quinolizinyl, isoquinolinyl, cinnolinyl, phthalazinyl, quinazolinyl, quinoxalinyl, 1,8-naphthridinyl, pteridinyl, carbazolyl, acridinyl, phenazinyl, phenothiazinyl, phenoxyazinyl, pyrazolo[1,5-c]triazinyl, and the like.

The term “aralkyl” refers to an alkyl group comprising one or more aryl substituent(s) wherein “aryl” and “alkyl” are as defined above. Non-limiting examples of aralkyl groups include benzyl, 2-phenyl-ethyl, 3-phenyl-propyl, 4-phenyl-butyl, 5-phenyl-pentyl, 4-phenylcyclohexyl, 4-benzylcyclohexyl, 4-phenylcyclohexylmethyl, 4-benzylcyclohexylmethyl, and the like.

The term “alkylene” refers to a functionalized or unfunctionalized, divalent, straight-chain, branched-chain, or cyclic hydrocarbyl group optionally having one or more heteroatoms. Non-limiting examples of alkylene groups include:

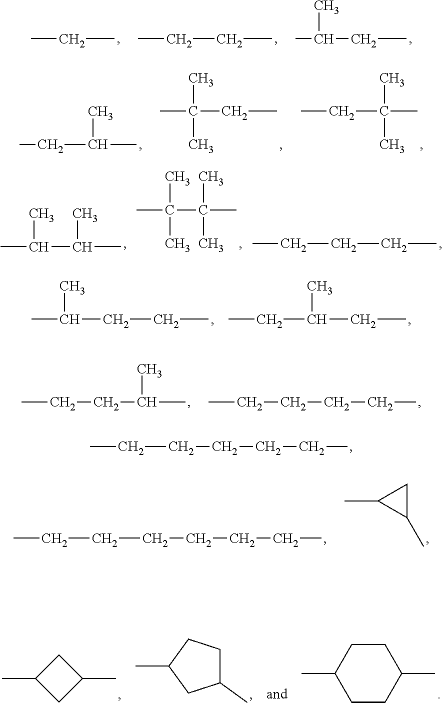

The term “arylene” refers to a functionalized or unfunctionalized, divalent, aromatic hydrocarbyl group optionally having one or more heteroatoms. The definition of arylene includes carbocyclic and heterocyclic groups. Non-limiting examples of arylene groups include phenylene, naphthylene, pyridinylene, and the like.

The term “heteroatom” refers to oxygen, nitrogen, sulfur, silicon, phosphorous, or halogen. The heteroatom(s) may be present as a part of one or more heteroatom-containing functional groups. Non-limiting examples of heteroatom-containing functional groups include ether, hydroxy, epoxy, carbonyl, carboxamide, carboxylic ester, carboxylic acid, imine, imide, amine, sulfonic, sulfonamide, phosphonic, and silane groups. The heteroatom(s) may also be present as a part of a ring such as in heteroaryl and heteroarylene groups.

The term “halogen” or “halo” refers to Cl, Br, I, or F.

The term “ammonium” includes protonated NH₃ and protonated primary, secondary, and tertiary organic amines.

The term “functionalized” with reference to any moiety refers to the presence of one or more functional groups in the moiety. Various functional groups may be introduced in a moiety by way of one or more functionalization reactions known to a person having ordinary skill in the art. Non-limiting examples of functionalization reactions include alkylation, epoxidation, sulfonation, hydrolysis, amidation, esterification, hydroxylation, dihydroxylation, amination, ammonolysis, acylation, nitration, oxidation, dehydration, elimination, hydration, dehydrogenation, hydrogenation, acetalization, halogenation, dehydrohalogenation, Michael addition, aldol condensation, Canizzaro reaction, Mannich reaction, Clasien condensation, Suzuki coupling, and the like. In one non-limiting embodiment, the term “functionalized” with reference to any moiety refers to the presence of one more functional groups selected from the group consisting of alkyl, alkenyl, hydroxyl, carboxyl, halogen, alkoxy, amino, imino, and combinations thereof, in the moiety.

The term “monomer” refers to a small molecule that chemically bonds during polymerization to one or more monomers of the same or different kind to form a polymer.

The term “polymer” refers to a large molecule comprising one or more types of monomer residues (repeating units) connected by covalent chemical bonds. By this definition, polymer encompasses compounds wherein the number of monomer units may range from very few, which more commonly may be called as oligomers, to very many. Non-limiting examples of polymers include homopolymers, and non-homopolymers such as copolymers, terpolymers, tetrapolymers and the higher analogues. The polymer may have a random, block, and/or alternating architecture.

The term “homopolymer” refers to a polymer that consists essentially of a single monomer type.

The term “non-homopolymer” refers to a polymer that comprises more than one monomer types.

The term “copolymer” refers to a non-homopolymer that comprises two different monomer types.

The term “terpolymer” refers to a non-homopolymer that comprises three different monomer types.

The term “branched” refers to any non-linear molecular structure. The term includes both branched and hyper-branched structures.

The term “block copolymer” refers to a polymer comprising at least two blocks of polymerized monomers. Any block may be derived from either a single monomer resulting in a homopolymeric subunit, or two or more monomers resulting in a copolymeric (or non-homopolymeric) subunit in the block copolymer. The block copolymers may be diblock copolymers (i.e., polymers comprising two blocks of monomers), triblock copolymers (i.e., polymers comprising three blocks of monomers), tetrablock copolymers (i.e., polymers comprising four blocks of monomers), or multiblock copolymers (i.e., polymers comprising more than four blocks of monomers), and combinations thereof. The block copolymers may be linear, branched, star or comb like, and have structures such as [A][B], [A][B][A], [A][B][C], [A][B][A][B], [A][B][C][B], etc. An exemplary representation of block copolymer is [A]ₓ[B]_{y} or [A]ₓ[B]_{y}[C]_{z}, wherein x, y and z are the degrees of polymerization (DP) of the corresponding blocks [A], [B], and [C]. Additional insight into the chemistry, characterization and applications of block copolymers may be found in the book ‘Block Copolymers: Synthetic Strategies, Physical Properties, and Applications’, by Nikos Hadjichristidis, Stergios Pispas, and George Floudas, John Wiley and Sons (2003), the contents of which are herein incorporated in its entirety by reference.

The term “controlled radical polymerization” refers to a specific radical polymerization process, also denoted by the term of “living radical polymerization”, in which use is made of control agents, such that the block copolymer chains being formed are functionalized by end groups capable of being reactivated in the form of free radicals by virtue of reversible transfer or reversible termination reactions.

The term “addition-fragmentation” refers to a two-step chain transfer mechanism during polymerization leading to homopolymers and block copolymers wherein a radical addition is followed by fragmentation to generate a new radical species.

The term RAFT refers to reversible addition-fragmentation chain transfer.

The term “free radical addition polymerization initiator” refers to a compound used in a catalytic amount to initiate a free radical addition polymerization. The choice of initiator depends mainly upon its solubility and its decomposition temperature.

The term “alkyl acrylate” refers to an alkyl ester of acrylic acid.

The term “alkyl acrylamide” refers to an alkyl amide of acrylic acid.

The term “alkyl methacrylate” refers to an alkyl ester of methacrylic acid.

The term “alkyl methacrylamide” refers to an alkyl amide of methacrylic acid.

The term “moiety” refers to a part or a functional group of a molecule.

In the block copolymer structures, the notation -b- on the polymer backbone denotes block configuration of repeating units. An exemplary block copolymer structure is shown below:

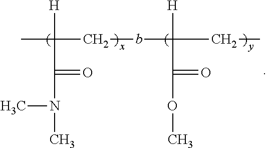

The terms “personal care composition” and “cosmetics” refer to compositions intended for use on or in the human body, such as skin, sun, hair, oral, cosmetic, and preservative compositions, including those to alter the color and appearance of skin and hair.

The term “pharmaceutical composition” refers to any composition comprising at least one pharmaceutically active ingredient, as well as any product which results, directly or indirectly, from combination, complexation, or aggregation of any two or more of the ingredients, from dissociation of one or more of the ingredients, or from other types of reactions or interactions of one or more of the ingredients.

The term “agrochemical composition” refers to any composition comprising at least one agrochemically active ingredient, as well as any product which results, directly or indirectly, from combination, complexation, or aggregation of any two or more of the ingredients, from dissociation of one or more of the ingredients, or from other types of reactions or interactions of one or more of the ingredients.

The term “pesticidal composition” refers to any composition comprising at least one pesticidally active ingredient, as well as any product which results, directly or indirectly, from combination, complexation, or aggregation of any two or more of the ingredients, from dissociation of one or more of the ingredients, or from other types of reactions or interactions of one or more of the ingredients.

The term “medical composition” refers to any composition comprising at least one medically active ingredient, as well as any product which results, directly or indirectly, from combination, complexation, or aggregation of any two or more of the ingredients, from dissociation of one or more of the ingredients, or from other types of reactions or interactions of one or more of the ingredients.

The term “biotechnological composition” refers to any composition comprising at least one biotechnologically active ingredient, as well as any product which results, directly or indirectly, from combination, complexation, or aggregation of any two or more of the ingredients, from dissociation of one or more of the ingredients, or from other types of reactions or interactions of one or more of the ingredients.

The term “coating composition” refers to an aqueous-based or solvent-based liquid composition that may be applied to a substrate and thereafter solidified (for example, by radiation, air curing, post-crosslinking or ambient temperature drying) to form a hardened coating on the substrate.

The term “oilfield composition” refers to a composition that may be used in the exploration, extraction, recovery, and/or completion of any hydrocarbon. Non-limiting examples of oilfield compositions include drilling fluids, cementing fluids, anti-agglomerants, kinetic hydrate inhibitors, shale swelling inhibitors, drilling muds, servicing fluids, gravel packing muds, friction reducers, fracturing fluids, completion fluids, and work over fluids.

The term “colloidal” refers to the state of matter having nanometer dimensions.

All percentages, ratio, and proportions used herein are based on a weight basis unless specified otherwise.

In a first aspect, the disclosed and/or claimed inventive concept(s) provides a polymer having the structure

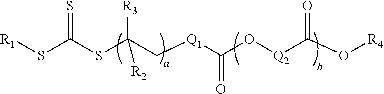

wherein R₄ is a C₁-C₄₀ functionalized or unfunctionalized hydrocarbyl moiety or

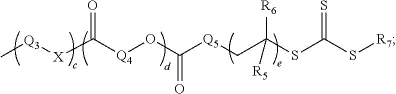

each R₁ and R₇ is independently a C₁-C₁₁ functionalized or unfunctionalized hydrocarbyl moiety; each R₂ and R₅ is independently hydrogen or methyl; each R₃ and R₆ is independently a C₁-C₄₀ functionalized or unfunctionalized hydrocarbyl moiety; each X is independently oxygen or NR₈; each R₈ is independently hydrogen or C₁-C₅ alkyl; each Q₁ and Q₅ is independently a C₁-C₁₀ functionalized or unfunctionalized hydrocarbylene moiety; each Q₂ and Q₄ is independently a C₃-C₈ functionalized or unfunctionalized alkylene moiety; each Q₃ is independently a functionalized or unfunctionalized hydrocarbylene moiety; and each a, b, d, and e independently ranges from about 5 to about 200, and c ranges from 1 to about 100.

In a second aspect, the disclosed and/or claimed inventive concept(s) provides a composition comprising a polymer having the structure

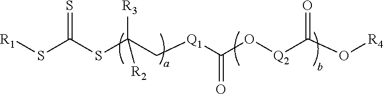

wherein R₄ is a C₁-C₄₀ functionalized or unfunctionalized hydrocarbyl moiety or

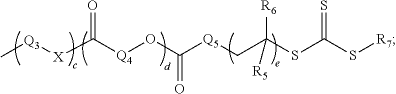

each R₁ and R₇ is independently a C₁-C₁₁ functionalized or unfunctionalized hydrocarbyl moiety; each R₂ and R₅ is independently hydrogen or methyl; each R₃ and R₆ is independently a C₁-C₄₀ functionalized or unfunctionalized hydrocarbyl moiety; each X is independently oxygen or NR₈; each R₈ is independently hydrogen or C₁-C₅ alkyl; each Q₁ and Q₅ is independently a C₁-C₁₀ functionalized or unfunctionalized hydrocarbylene moiety; each Q₂ and Q₄ is independently a C₃-C₈ functionalized or unfunctionalized alkylene moiety; each Q₃ is independently a functionalized or unfunctionalized hydrocarbylene moiety; and each a, b, d, and e independently ranges from about 5 to about 200, and c ranges from 1 to about 100.

In a third aspect, the disclosed and/or claimed inventive concept(s) provides a method for reducing particle size of at least one active ingredient comprising: (a) contacting to form a mixture, the active ingredient in a solid form and a colloidal composition comprising a polymer having the structure

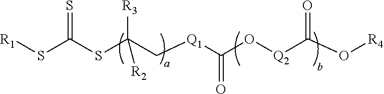

wherein R₄ is a C₁-C₄₀ functionalized or unfunctionalized hydrocarbyl moiety or

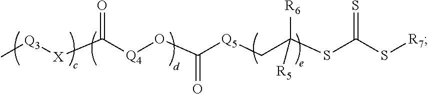

each R₁ and R₇ is independently a C₁-C₁₁ functionalized or unfunctionalized hydrocarbyl moiety; each R₂ and R₅ is independently hydrogen or methyl; each R₃ and R₆ is independently a C₁-C₄₀ functionalized or unfunctionalized hydrocarbyl moiety; each X is independently oxygen or NR₈; each R₈ is independently hydrogen or C₁-C₅ alkyl; each Q₁ and Q₅ is independently a C₁-C₁₀ functionalized or unfunctionalized hydrocarbylene moiety; each Q₂ and Q₄ is independently a C₃-C₈ functionalized or unfunctionalized alkylene moiety; each Q₃ is independently a functionalized or unfunctionalized hydrocarbylene moiety; and each a, b, d, and e independently ranges from about 5 to about 200, and c ranges from 1 to about 100; and (b) subjecting the mixture to at least one particle size reduction operation.

In one non-limiting embodiment, the polymer according to the disclosed and/or claimed inventive concept(s) has a structure

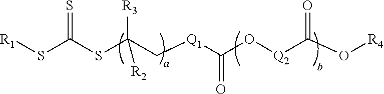

wherein R₁ is a C₁-C₁₁ functionalized or unfunctionalized hydrocarbyl moiety; each R₂ is independently hydrogen or methyl; each R₃ is independently a C₁-C₄₀ functionalized or unfunctionalized hydrocarbyl moiety; R₄ is a C₁-C₄₀ functionalized or unfunctionalized hydrocarbyl moiety; Q₁ is a C₁-C₁₀ functionalized or unfunctionalized hydrocarbylene moiety; each Q₂ is independently a C₃-C₈ functionalized or unfunctionalized alkylene moiety; and each a and b ranges from about 5 to about 200.

In another non-limiting embodiment, the polymer according to the disclosed and/or claimed inventive concept(s) has a structure

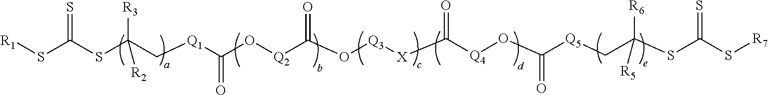

wherein each R₁ and R₇ is independently a C₁-C₁₁ functionalized or unfunctionalized hydrocarbyl moiety; each R₂ and R₅ is independently hydrogen or methyl; each R₃ and R₆ is independently a C₁-C₄₀ functionalized or unfunctionalized hydrocarbyl moiety, each X is independently oxygen or NR₈; each R₈ is independently hydrogen or C₁-C₅ alkyl; each Q₁ and Q₅ is independently a C₁-C₁₀ functionalized or unfunctionalized hydrocarbylene moiety; each Q₂ and Q₄ is independently a C₃-C₈ functionalized or unfunctionalized alkylene moiety; each Q₃ is independently a functionalized or unfunctionalized hydrocarbylene moiety; and each a, b, d, and e independently ranges from about 5 to about 200, and c ranges from 1 to about 100.

In one non-limiting embodiment, Q₂ is a propylene, butylene, pentamethylene, or hexamethylene moiety. In another non-limiting embodiment, each Q₂ and Q₄ is a propylene, butylene, pentamethylene, or hexamethylene moiety.

In one non-limiting embodiment, Q₃ is ethylene, propylene, or butylene moiety and X is oxygen.

In one non-limiting embodiment, a ranges from about 10 to about 150 and said b ranges from about 10 to 50. In another non-limiting embodiment, each a and e ranges from about 10 to about 150 and each b and d ranges from about 10 to 50.

In one non-limiting embodiment, a and e are identical and b and d are identical.

In one non-limiting embodiment, each R₁ and R₇ is a C₁-C₅ alkyl. In another non-limiting embodiment, R₁ and R₇ are identical.

In one non-limiting embodiment, Q₁ is a C₁-C₅ functionalized or unfunctionalized hydrocarbylene moiety. In another non-limiting embodiment, each Q₁ and Q₅ is a C₁-C₅ functionalized or unfunctionalized hydrocarbylene moiety.

In one non-limiting embodiment, c ranges from 1 to about 10.

In one non-limiting embodiment, each R₈ is independently a functionalized or unfunctionalized C₁-C₁₀ hydrocarbyl moiety.

In one non-limiting embodiment, each R₃ is independently selected from the group consisting of

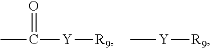

R₉, and combinations thereof, wherein each R₉ is independently a functionalized or unfunctionalized C₁-C₄₀ hydrocarbyl moiety, each Y is independently oxygen, sulfur, or NR₁₀, and each R₁₀ is independently hydrogen or C₁-C₅ alkyl.

In one non-limiting embodiment, each R₃ and R₆ is independently selected from the group consisting of

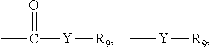

R₉, and combinations thereof, wherein each R₉ is independently a functionalized or unfunctionalized C₁-C₄₀ hydrocarbyl moiety, each Y is independently oxygen, sulfur, or NR₁₀, and each R₁₀ is independently hydrogen or C₁-C₅ alkyl.

In one non-limiting embodiment, each R₉ is independently selected from the group consisting of methyl, ethyl, isopropyl, n-butyl, isobutyl, sec-butyl, n-pentyl, 2-hydroxyethyl, 2-pyrrolidonylethyl, cyclohexyl, and combinations thereof.

In one non-limiting embodiment, each R₄ is a C₁-C₁₀ functionalized or unfunctionalized hydrocarbyl moiety.

In one non-limiting embodiment, the polymer according to the disclosed and/or claimed inventive concept(s) has a structure selected from the group consisting of

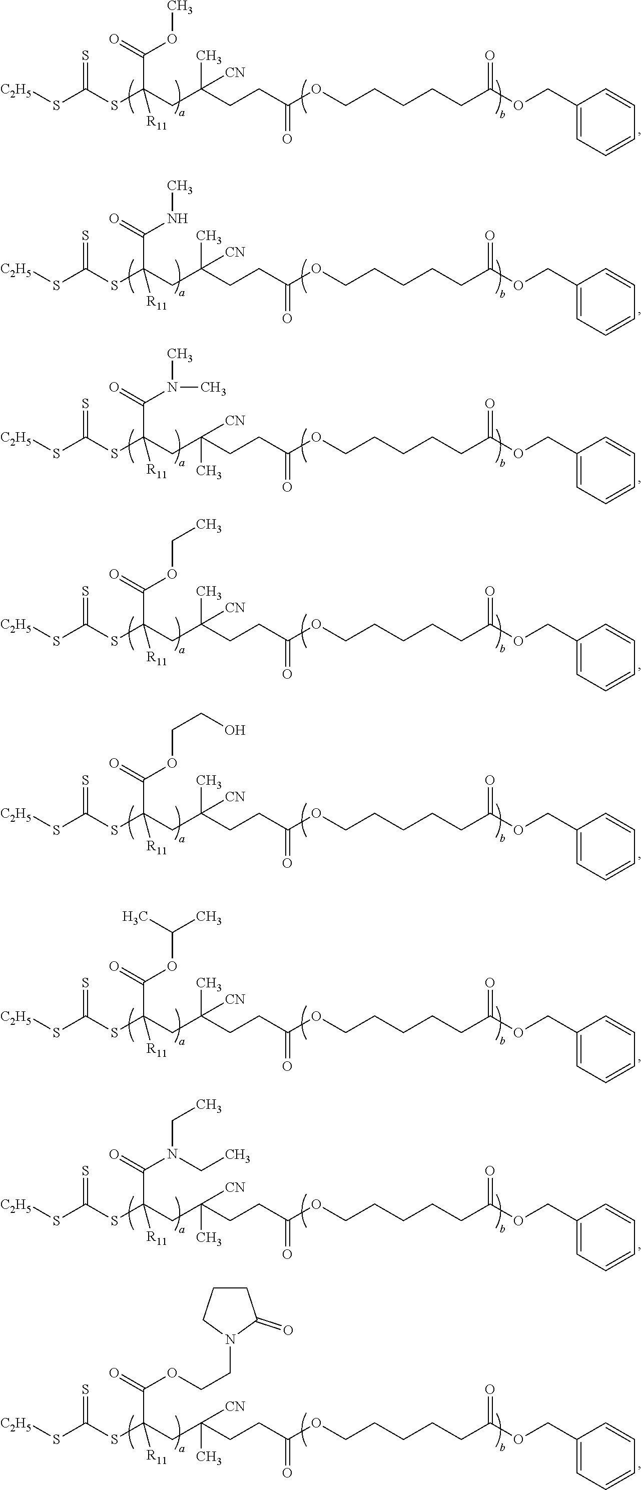

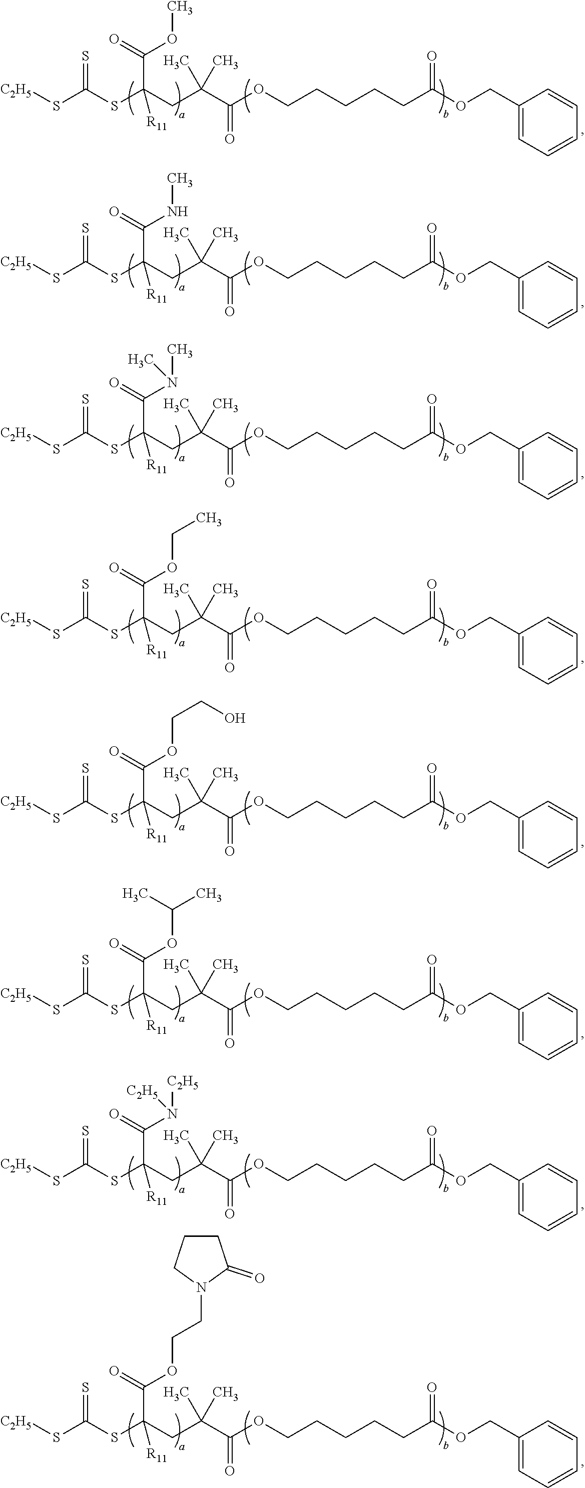

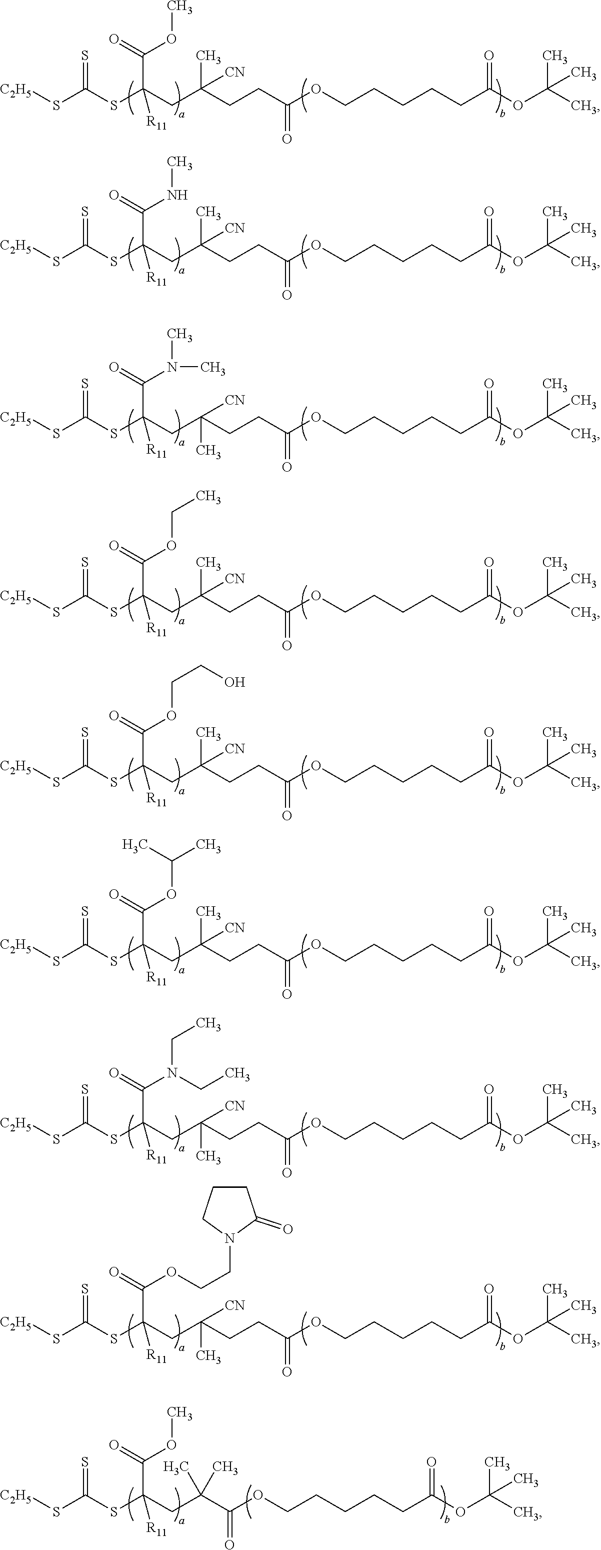

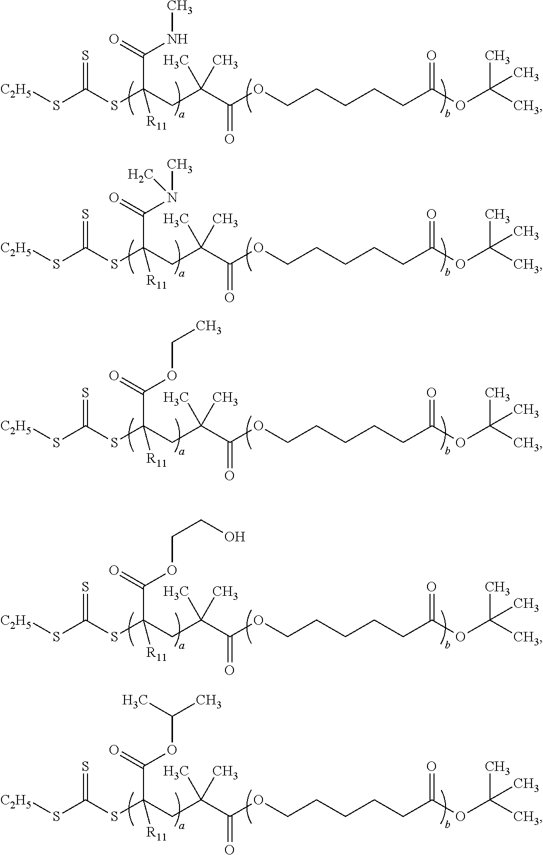

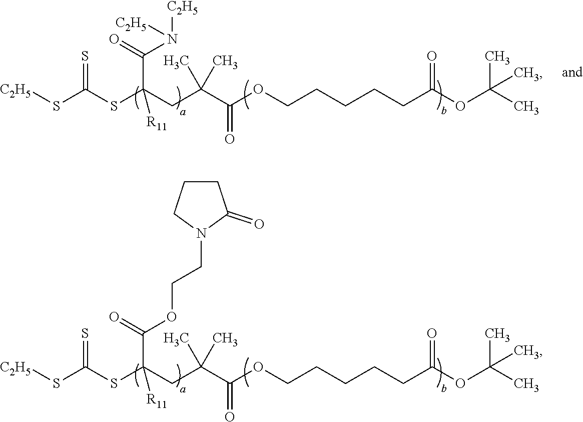

wherein a ranges from about 10 to about 150, b ranges from about 10 to 50, and each R₁ is independently selected from the group consisting of hydrogen, methyl, and combinations thereof.

In one non-limiting embodiment, the polymer according to the disclosed and/or claimed inventive concept(s) has a structure selected from the group consisting of

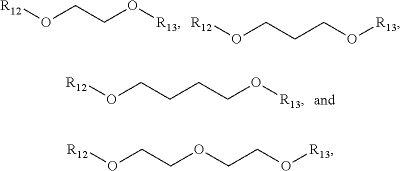

wherein each R₁₂ and R₁₃ is independently selected from the group consisting of

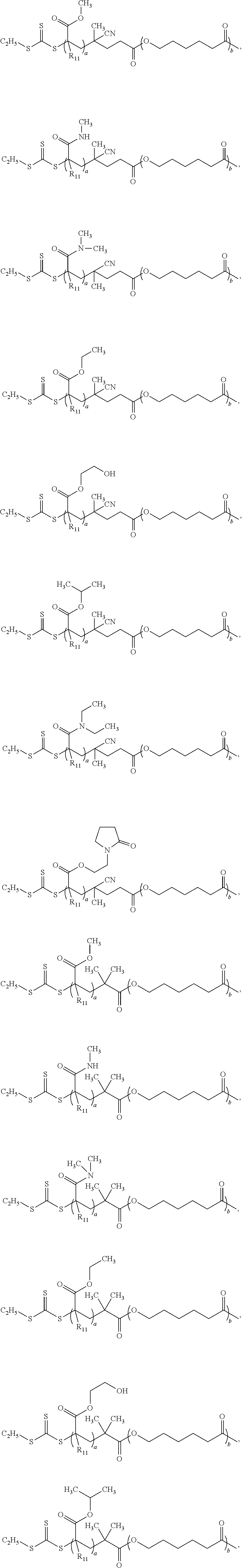

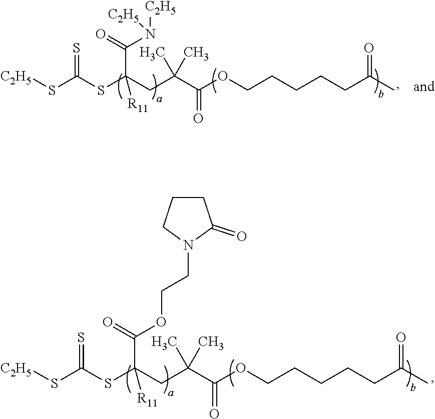

wherein a ranges from about 10 to about 150, b ranges from about 10 to 50, and each Rn is independently selected from the group consisting of hydrogen, methyl, and combinations thereof.

In one non-limiting embodiment, R₁₂ and R₁₃ are identical.

In one non-limiting embodiment, the composition according to the disclosed and/or claimed inventive concept(s) is in the form of colloidal particles.

In one non-limiting embodiment, the colloidal particles are spherical in shape.

In one non-limiting embodiment, the colloidal particles have an average diameter ranging from about 1 to about 1000 nanometer. In another non-limiting embodiment, the colloidal particles have an average diameter ranging from about 5 to about 100 nanometer.

In one non-limiting embodiment, the composition is an agrochemical composition, pharmaceutical composition, medical composition, biotechnological composition, pesticide composition, personal care composition, coating composition, construction composition, nutritional composition, adhesive composition, oilfield composition, household, industrial and institutional composition, thermoplastic composition, cementing fluid, servicing fluid, gravel packing mud, fracturing fluid, completion fluid, work-over fluid, spacer fluid, drilling mud, biocide, ink, paper, polish, membrane, metal working fluid, plastic, textile, printing composition, lubricant, detergent, battery composition, glass coating composition, or preservative composition.

In one non-limiting embodiment, the composition further comprises at least one additive selected from the group consisting of solubilizers, binders, lubricants, surfactants, oils, waxes, solvents, emulsifiers, preservatives, antioxidants, antiradical protecting agents, vitamins, perfumes, insect repellants, dyes, pigments, humectants, fillers, thickeners, film formers, stabilizers, buffers, spreading agents, electrolytes, acids, bases, structuring agents, abrasives, and combinations thereof.

In one non-limiting embodiment, the active ingredient according to the disclosed and/or claimed inventive concept(s) is selected from the group consisting of an agrochemical active ingredient, a pesticidal active ingredient, a pharmaceutical active ingredient, a medical active ingredient, a biotechnological active ingredient, or combinations thereof.

In one non-limiting embodiment, the colloidal composition according to the disclosed and/or claimed inventive concept(s) comprises spherical colloidal particles of the inventive polymers described herein.

In one non-limiting embodiment, the spherical colloidal particles have an average diameter ranging from about 1 to about 1000 nanometer. In one non-limiting embodiment, the spherical colloidal particles have an average diameter ranging from about 5 to about 100 nanometer.

In another non-limiting embodiment, the colloidal particles have non-spherical morphologies. Non-limiting examples of colloidal particles having non-spherical morphologies include worms and vesicles. Further insight into the structure and properties of colloidal particles may be found in the publication J. Am. Chem. Soc., 2014, volume 136, 10174-10185, the contents of which are herein incorporated in its entirety be reference.

In one non-limiting embodiment, the active ingredient according to the disclosed and/or claimed inventive concept(s) is in a solid form selected from the group consisting of crystalline form, semicrystalline form, polymorphous form, amorphous form, cocrystal form, and combinations thereof.

In one non-limiting embodiment, the method for reducing particle size of at least one active ingredient according to the disclosed and/or claimed inventive concept(s) is ball milling. Details on ball milling and other methods used for reduction of particle size of active ingredients may be found in the publication Journal of Pharmaceutical Innovation, 2022, volume 17, 333-352, the contents of which are herein incorporated in its entirety by reference.

Non-limiting examples of personal care compositions include sun care compositions, face care compositions, lip care compositions, eye care compositions, skin care compositions, after-sun compositions, body care compositions, nail care compositions, anti-aging compositions, insect repellants, oral care compositions, deodorant compositions, hair care compositions, conditioning compositions, color cosmetic compositions, color-protection compositions, self-tanning compositions, and foot care compositions.

The personal care compositions may further comprise at least one additive selected from the group consisting of UV actives, UV active solubilizers, oils, waxes, solvents, emulsifiers, preservatives, antioxidants, antiradical protecting agents, vitamins, perfumes, insect repellants, dyes, pigments, humectants, fillers, thickeners, film formers, stabilizers, buffers, spreading agents, pearlizing agents, electrolytes, acids, bases, crystalline structuring agents, abrasives, pharmaceutically or cosmetically acceptable excipients, and combinations thereof.

Non-limiting applications of hair care compositions include hairstyle retention at high relative humidity, hair styling, hair setting, hair sculpting, hair curling, hair holding, hair waving, hair fixing, hair maintaining, hair shaping, hair straightening, hair volumizing, hair relaxing, shampooing, hair conditioning, hair cleansing, promoting hair style durability, imparting humidity resistance to hair and hair styles, enhancing hair shine, repairing split ends of hair, enhancing hair manageability such as lightness, smoothness, softness, disentangling and/or suppleness of hair, modulating hair stylability, protecting hair from thermal damage, hair dyeing, hair coloring, hair bleaching, oxidation dyeing of hair, limiting hair color bleeding, protecting hair color, hair treating (e.g., anti-dandruff), anti-hair fall, and/or protecting hair from UV radiation.

Non-limiting examples of hair care compositions include shampoos, conditioners, aerosols, mousses, sprays, mists, gels, waxes, creams, lotions, glues, pomades, spritzes, solutions, oils, liquids, solids, W/O emulsions, O/W emulsions, suspensions, multiple emulsions, microemulsions, microencapsulated products, sticks, balms, tonics, pastes, reconstitutable products, nanoemulsions, solid lipid nanoparticles, liposomes, cubosomes, neosomes, putties, lacquers, serums, perms, volumizers, packs, flakes, 2-in-1 shampoo/conditioner products, and 3-in-1 shampoo/conditioner/styling products.

Non-limiting examples of suitable UV actives include: octyl salicylate; pentyl dimethyl PABA; octyl dimethyl PABA; benzophenone-1; benzophenone-6; 2-(2H-benzotriazole-2-yl)-4,6-di-tert-pentylphenol; ethyl-2-cyano-3,3-diphenylacrylate; homomenthyl salicylate; bis-ethylhexyloxyphenol methoxyphenyl triazine; methyl-(1,2,2,6,6-pentamethyl-4-piperidyl)-sebacate; 2-(2H-benzotriazole-2-yl)-4-methylphenol; diethylhexyl butamido triazone; amyl dimethyl PABA; 4,6-bis(octylthiomethyl)-o-cresol; CAS number 65447-77-0; red petroleum; ethylhexyl triazone; octocrylene; isoamyl-p-methoxycinnamate; drometrizole; titanium dioxide; 2,4-di-tert-butyl-6-(5-chloro-2H-benzotriazole-2-yl)-phenol; 2-hydroxy-4-octyloxybenzophenone; benzophenone-2; diisopropyl methylcinnamate; PEG-25 PABA; 2-(1,1-dimethylethyl)-6-[[3-(1,1-demethylethyl)-2-hydroxy-5-methylphenyl]methyl-4-methylphenyl acrylate; drometrizole trisiloxane; menthyl anthranilate; butyl methoxydibenzoylmethane; 2-ethoxyethyl p-methoxycinnamate; benzylidene camphor sulfonic acid; dimethoxyphenyl-[1-(3,4)]-4,4-dimethyl 1,3-pentanedione; zinc oxide; N,N′-hexane-1,6-diylbis[3-(3,5-di-tert-butyl-4-hydroxyphenylpropionamide)]; pentaerythritol tetrakis[3-(3,5-di-tert-butyl-4-hydroxyphenyl)propionate]; 2,6-di-tert-butyl-4-[4,6-bis(octylthio)-1,3,5-triazin-2-ylamino]phenol; 2-(2H-benzotriazole-2-yl)-4,6-bis(1-methyl-1-phenylethyl)phenol; trolamine salicylate; diethylanolamine p-methoxycinnamate; polysilicone-15; CAS number 152261-33-1; 4-methylbenzylidene camphor; bisoctrizole; n-phenyl-benzenamine; reaction products with 2,4,4-trimethylpentene; sulisobenzone; (2-ethylhexyl)-2-cyano-3,3-diphenylacrylate; digalloyl trioleate; polyacrylamido methylbenzylidene camphor; glyceryl ethylhexanoate dimethoxycinnamate; 1,3-bis-[(2′-cyano-3′,3′-diphenylacryloyl)oxy]-2,2-bis-{[(2′-cyano-bis-(2,2,6,6-tetramethyl-4-piperidyl)-sebacate; benzophenone-5; 1,3,5-tris(3,5-di-tert-butyl-4-hydroxybenzyl)-1,3,5-triazine-2,4,6(1H,3H,5H)-trione; hexamethylendiamine; benzophenone-8; ethyl-4-bis(hydroxypropyl) aminobenzoate; 6-tert-butyl-2-(5-chloro-2H-benzotriazole-2-yl)-4-methylphenol; p-aminobenzoic acid; 3,3′,3″,5,5′,5″-hexa-tert-butyl-α-α′-α″-(mesitylene-2,4,6-triyl)tri-p-cresol; lawsone with dihydroxyacetone; benzophenone-9; benzophenone-4; ethylhexyl dimethoxy benzylidene dioxoimidazoline propionate; N,N′-bisformyl-N,N′-bis-(2,2,6,6-tetramethyl-4-piperidinyl)-; 3-benzylidene camphor; terephthalylidene dicamphor sulfonic acid; camphor benzalkonium methosulfate; bisdisulizole disodium; etocrylene; ferulic acid; 2-(2H-benzotriazole-2-yl)-4-(1,1,3,3-tetramethylbutyl)-phenol; 4,6-bis(dodecylthiomethyl)-o-cresol; β-2-glucopyranoxy propyl hydroxy benzophenone; phenylbenzimidazole sulfonic acid; benzophenone-3; diethylamine hydroxybenzoyl hexylbenzoate; 3′,3′-diphenylacryloyl)oxy]methyl}-propane; ethylhexyl p-methoxycinnamate, and blends thereof.

Non-limiting examples of suitable antioxidants and/or antiradical protecting agents include: BHA (tert-butyl-4-hydroxy anisole), BHT (2,6-di-tert-butyl-p-cresol), TBHQ (tert-butyl hydroquinone), polyphenols such as proanthocyanodic oligomers, flavonoids, hindered amines such as tetra amino piperidine, erythorbic acid, polyamines such as spermine, cysteine, glutathione, superoxide dismutase, lactoferrin, and blends thereof.

Any range of composition pH may be used. In aspects wherein the composition may be applied to keratinous material, the pH may range from about 2 to 12. The pH may be adjusted to a desired value by means of adding one or more acidifying or alkalinizing agents that are well-known in the state of the art. For example, the composition can contain at least one alkalizing or acidifying agent in amounts from about 0.01% to about 30% based on the total weight of the composition.

Non-limiting examples of acidifying or acidic pH adjusting agents include organic acids, such as citric acid, acetic acid, carboxylic acids, α-hydroxyacids, β-hydroxyacids, α,β-hydroxyacids, salicylic acid, tartaric acid, lactic acid, glycolic acid, natural fruit acids, and combinations thereof. In addition, inorganic acids, for example hydrochloric acid, nitric acid, sulfuric acid, sulfamic acid, phosphoric acid, and combinations thereof can be utilized.

Non-limiting examples of alkalizing or alkaline pH adjusting agents include ammonia, alkali metal hydroxides (such as sodium hydroxide and potassium hydroxide), ammonium hydroxide, alkanolamines (such as mono-, di- and triethanolamine), diisopropylamine, dodecylamine, diisopropanolamine, aminomethyl propanol, cocamine, oleamine, morpholine, triamylamine, triethylamine, tromethamine (2-amino-2-hydroxymethyl)-1,3-propanediol), and tetrakis(hydroxypropyl)ethylenediamine, hydroxyalkylamines and ethoxylated and/or propoxylated ethylenediamines, alkali metal salts of inorganic acids, such as sodium borate (borax), sodium phosphate, sodium pyrophosphate, and the like, and mixtures thereof.

Non-limiting examples of alkalizing agent can be chosen from ammonia, alkali carbonates, alkanolamines, like mono-, di- and triethanolamines, as well as their derivatives, sodium or potassium hydroxides and compounds of the following formula:

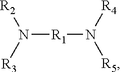

wherein R₁ may be a propylene residue that may be optionally substituted with an hydroxyl group or a C₁-C₄ alkyl radical; R₂, R₃, R₄ and R₅ are identical or different and represent a hydrogen atom, a C₁-C₄ alkyl radical or C₁-C₄ hydroxyalkyl radical.

The personal care compositions may additionally comprise one or more buffers. Suitable buffering agents include, but are not limited to alkali or alkali earth carbonates, phosphates, bicarbonates, citrates, borates, acetates, acid anhydrides, succinates and the like, such as sodium phosphate, citrate, borate, acetate, bicarbonate, and carbonate.

The personal care compositions may be formulated in any of the product forms known to a person of ordinary skill in the art. Non-limiting product forms are described below.

### Product Forms

Non-limiting sun care product forms include: solutions, liquids, creams, powders, lotions, gels, pastes, waxes, aerosols, sprays, mists, roll-ons, sticks, milks, emulsions, and wipes.

Non-limiting skin care product forms include: solutions, oils, lotions, creams, ointments, liquids, gels, solids, W/O emulsions, O/W emulsions, milks, suspensions, microemulsions, dispersions, microencapsulated products, sticks, balms, tonics, pastes, mists, reconstitutable products, peels, soaps, aerosols, mousses, waxes, glues, pomades, spritzes, putties, lacquers, serums, perms, powders, pencils, flakes, blush, highlighters, bronzers, concealers, and 2-way cake products.

The compositions may also take the form of skin-washing compositions, and in the form of solutions or gels for the bath or shower, or of make-up removal products.

The six skin care product categories that follow next may be considered a subset of the skin and sun care products:

### (1) Eye Care

Non-limiting eye care product forms include: mascaras, eye liners, eye shadows, curlers of eye lashes, eyebrow pencils, and eye pencils.

### (2) Lip Care

Non-limiting lip care product forms include: lipsticks, lip balms, lip pencils, lip glosses, lip sprays, transparent lip bases, tinted lip moisturizers, and multi-functional color sticks that can also be used for cheeks and eyes.

### (3) Nail Care

Non-limiting nail care product forms include: nail polishes, nail varnishes, enamels, nail varnish removers, home-manicure products such as cuticle softeners and nail strengtheners, and artificial nails.

### (4) Face Care

Non-limiting face care product forms include: creams, lotions, solutions, oils, liquids, peels, scrubs, emulsions, suspensions, microemulsions, microencapsulated product, pastes, reconstitutable product, aerosols, mousses, gels, waxes, glues, pomades, spritzes, facial wet-wipes, putties, lacquers, serums, perms, powders, blush, highlighters, bronzers, masks, and concealers.

### (5) Body Care

Non-limiting body care product forms include: foams, peels, masks, gels, sticks, aerosols, lotions, salts, oils, balls, liquids, powders, peels, pearls, bar soaps, liquid soaps, body washes, cleansers, scrubs, creams, flakes, other bath and shower products, shaving products, waxing products, and sanitizers.

### (6) Foot Care

Non-limiting foot care product forms include: mousses, creams, lotions, powders, liquids, sprays, aerosols, gels, flakes, and scrubs.

Non-limiting oral care product forms include: toothpastes, adhesives, gums, gels, powders, creams, solutions, lotions, liquids, dispersions, suspensions, emulsions, tablets, capsules, rinses, flosses, aerosols, strips, films, pads, bandages, microencapsulated products, syrups, and lozenges.

Also contemplated are personal care compositions comprising polymer(s) described herein complexed with iodine. These compositions may be used in treating skin conditions, non-limiting examples of which include dermatitis, wounds, bacterial infections, burns, rashes, and herpes. These complexed compositions may be staining, substantially non-staining, or essentially non-staining.

Examples of related personal care compositions are disclosed in U.S. Pat. Nos. 5,599,800; 5,650,166; 5,916,549; and 6,812,192; U.S. patent application 2009/0317432; EP556660; EP661037; EP661038; EP662315; EP676194; EP796077; EP970682; EP976383; EP1415654; and EP2067467; and WO2005/032506; each of which is herein incorporated in its entirety by reference.

It is also contemplated that the personal care compositions may be used in products for male and/or female personal grooming and/or toiletry such as: sanitary napkins, baby diapers, adult diapers, feminine products, products for incontinence, and other related products.

An array of additional personal care compositions, methods, and uses are contemplated. Disclosure of these compositions may be found in the following brochures by Ashland Specialty Ingredients (Bridgewater, NJ), each of which is herein incorporated in its entirety by reference: Plasdone™ K-29 32, Advanced non-oxidative, non-abrasive teeth whitening in toothpastes, mouthwashes, and oral rinses (2010), Polymers for oral care, product and applications guide (2002), A composition guide for excellent hair styling gels and lotions (4/2003), PVP (polyvinylpyrrolidone) (no date provided), and Textile chemicals, solutions for the most challenging product environment (no date provided).

Also contemplated are personal care compositions described in the publications listed below, each of which is herein incorporated in its entirety by reference: (1) Prototype Compositions—Personal Care Products (2009) from Xiameter, Dow Corning. (2) Sun care compositions under the category “Refreshing Sun”, “Younger Sun”, “Sun for Men”, and “Sunny Glow” from Dow Corning. (3) Cosmetic Nanotechnology, Polymers and Colloids in Cosmetics, 2007, ACS Symposium Series. (4) Review Paper: Lipid nanoparticles (SLN, NLC) in cosmetic and pharmaceutical dermal products, International Journal of Pharmaceutics, Volume 366, 2009.

### Optional: Additional Composition Ingredients

It is also contemplated that the personal care compositions optionally may contain one or more additional ingredients.

Further, it is contemplated that the composition ingredients may be formulated in a single container, or the ingredients may be formulated in-part in two or more distinct containers of the same or different type, the contents of which may require mixing prior to use.

Furthermore, it also is contemplated that the compositions may be prepared in the form of concentrates that may be diluted by a suitable substance(s) prior to use. The concentrate may, in turn, be present in any of the forms as described under ‘Product Forms’ for the personal care compositions of the invention.

Anon-limiting list of classes of additional ingredients that may optionally be present in different types of personal care compositions is provided below: conditioning agents, antimicrobials, protectives (for example, antiradical agents), abrasives, UV absorbers, emulsifiers (including, but not limited to ethoxylated fatty acids, ethoxylated glyceryl esters, ethoxylated oils, ethoxylated sorbitan esters, fatty esters, PEG esters, polyglycerol esters), antiperspirants (including, but not limited to aluminium chlorohydrates, aluminium zirconium chlorohydrates), antioxidants, vitamins and/or provitamins, botanicals, fixatives, oxidizing agents, reducing agents, dyes, cleansing agents, anionic, cationic, nonionic, and/or amphoteric surfactants, thickeners and/or gelling agents, perfumes, flavors, and/or fragrances, pearlizing agents, stabilizers, pH adjusters, filters, antimicrobial agents, preservatives and/or disinfectants, associative polymers, oils of vegetable, mineral, and/or synthetic origin, polyols, silicones, colorants, bleaching agents, highlighting agents, propellants (including, but not limited to hydrocarbons, dimethyl ether, fluorocarbons), styling polymers, benefit agents, skin lighteners (including, but not limited to arbutin and kojic acids), tanning agents (including, but not limited to dihydroxyacetone), solvents and/or cosolvents, diluents, essential oils, sequestrants and/or chelators, carriers, and natural extracts and/or natural products.

The amount of each ingredient in the composition varies depending on the type of composition, the function and/or physicochemical property of the ingredient, and the amount of other co-ingredients. The precise amount of each ingredient may be easily determined by any person skilled in the related arts.

It may be desirable to include one or more ingredients described in the prior art disclosures IPCOM000186541D, IPCOM000128968D, and IPCOM000109682D on www.ip.com, the contents of each of these disclosures are herein incorporated in their entirety by reference.

Further reference to formulary co-ingredients and product forms include the disclosures in US 2010/0183532, paragraphs [0096]-[0162], and WO 2010/105050, paragraphs [0053][0069], the contents of which are herein incorporated in their entirety by reference.

Any known conditioning agent may be used in the personal care compositions. An extensive discussion on conditioning agents may be found in the book Conditioning Agents for Skin and Hair, Cosmetic Science and Technology Series, Volume 21, 1999, Marcel Dekker Publishers. The contents of the book are herein incorporated in its entirety by reference.

Conditioning agents may be chosen from synthetic oils, mineral oils, vegetable oils, fluorinated or perfluorinated oils, natural or synthetic waxes, silicones, cationic polymers, proteins and hydrolyzed proteins, cationic surfactants, ceramide type compounds, fatty amines, fatty acids and their derivatives, as well as mixtures of these different types of compounds.

Non-limiting examples of suitable synthetic oils include: polyolefins, e.g., poly-α-olefins, such as polybutenes, polyisobutenes, polydecenes, and blends thereof. The polyolefins may be hydrogenated.

Non-limiting examples of suitable mineral oils include hexadecane and oil of paraffin.

Non-limiting examples of suitable animal and vegetable oils include: sunflower oil, corn oil, soy oil, avocado oil, jojoba oil, squash oil, raisin seed oil, sesame seed oil, walnut oil, fish oil, glycerol tricaprocaprylate, purcellin oil, liquid jojoba, and blends thereof. Also suitable are natural oils such as oils of Eucalyptus, lavender, vetiver, Litsea cubeba, lemon, sandalwood, rosemary, chamomile, savory, nutmeg, cinnamon, hyssop, caraway, orange, geranium, cade, bergamot, and blends thereof.

The conditioning agent may be a fluorinated or a perfluorinated oil. The fluoridated oils may also be fluorocarbons such as fluoramines, e.g., perfluorotributylamine, fluoridated hydrocarbons such as perfluorodecahydronaphthalene, fluoroesters, fluoroethers, and blends thereof.

Non-limiting examples of suitable natural and synthetic waxes include: carnauba wax, candelila wax, alfa wax, paraffin wax, ozokerite wax, vegetable waxes such as olive wax, rice wax, hydrogenated jojoba wax, absolute flower waxes such as black currant flower wax, animal waxes such as bees wax, modified bees wax (cerabellina), marine waxes and polyolefin waxes such as polyethylene wax, and blends thereof.

The conditioning agent may be any silicone known by those skilled in the art. Silicones include polyorganosiloxanes that are insoluble in the composition. The silicones may be present in the form of oils, waxes, resins, or gums. They may be volatile or non-volatile.

Non-limiting examples of suitable silicones include: polyalkyl siloxanes, polyaryl siloxanes, polyalkyl aryl siloxanes, silicone gums and resins, polyorgano siloxanes modified by organofunctional groups, and blends thereof.

Suitable polyalkyl siloxanes include polydimethyl siloxanes with terminal trimethyl silyl groups or terminal dimethyl silanol groups (dimethiconol) and polyalkyl (C1-C20) siloxanes. Suitable polyalkyl aryl siloxanes include polydimethyl methyl phenyl siloxanes and polydimethyl diphenyl siloxanes. The siloxanes can have a linear or branched structure.

Suitable silicone gums include polydiorganosiloxanes, such as those having a number-average molecular weight between 200,000 Da and 1,000,000 Da used alone or mixed with a solvent.

Non-limiting examples of suitable silicone gums include: polymethyl siloxane, polydimethyl siloxane/methyl vinyl siloxane gums, polydimethyl siloxane/diphenyl siloxane, polydimethyl siloxane/phenyl methyl siloxane, polydimethyl siloxane/diphenyl siloxane/methyl vinyl siloxane, and blends thereof.

Non-limiting examples of suitable silicone resins include silicones with a dimethyl/trimethyl siloxane structure and resins of the trimethyl siloxysilicate type.

The organo-modified silicones suitable for use include silicones such as those previously defined and containing one or more organofunctional groups attached by means of a hydrocarbon radical, and grafted silicone polymers. The organo-modified silicones may be one from the amino functional silicone family.

The silicones may be used in the form of emulsions, nano-emulsions, or micro-emulsions.

The cationic polymers that may be used as conditioning agents generally have a molecular weight (average number) from about 500 Da to about 5,000,000 Da. The expression “cationic polymer” as used herein indicates any polymer having at least one cationic group.

The cationic polymers may be chosen from among polymers containing primary, secondary, tertiary amine, and/or quaternary ammonium groups that may form part of the main polymer backbone and/or side chain(s).

Non-limiting examples of suitable cationic polymers include polyamines, polyaminoamides, and quaternary polyammonium classes of polymers, such as:

(1) homopolymers and copolymers derived from acrylic or methacrylic esters or amides. The copolymers may contain one or more units derived from acrylamides, methacrylamides, diacetone acrylamides, acrylic or methacrylic acids or their esters, vinyl lactams such as vinyl pyrrolidone or vinyl caprolactam, and vinyl esters. Non-limiting, specific examples include: copolymers of acrylamide and dimethyl amino ethyl methacrylate quaternized with dimethyl sulfate or with an alkyl halide; copolymers of acrylamide and methacryloyl oxyethyl trimethyl ammonium chloride; the copolymer of acrylamide and methacryloyl oxyethyl trimethyl ammonium methosulfate; copolymers of vinyl pyrrolidone and dialkylaminoalkyl acrylate or methacrylate, optionally quaternized, such as the products sold under the name Gafquat™ by Ashland Specialty Ingredients (Bridgewater, NJ); terpolymers of dimethyl amino ethyl methacrylate, vinyl caprolactam, and vinyl pyrrolidone such as the product sold under the name Gaffix™ VC 713 by Ashland Specialty Ingredients (Bridgewater, NJ); the vinyl pyrrolidone/methacrylamidopropyl dimethylamine copolymer, marketed under the name Styleze™ CC 10 by Ashland Specialty Ingredients (Bridgewater, NJ); and the vinyl pyrrolidone/quaternized dimethyl amino propyl methacrylamide copolymers such as the product sold under the name Gafquat™ HS 100 by Ashland Specialty Ingredients (Bridgewater, NJ).

(2) derivatives of cellulose ethers containing quaternary ammonium groups, such as hydroxy ethyl cellulose quaternary ammonium that has reacted with an epoxide substituted by a trimethyl ammonium group.

(3) derivatives of cationic cellulose such as cellulose copolymers or derivatives of cellulose grafted with a hydrosoluble quaternary ammonium monomer, as described in U.S. Pat. No. 4,131,576, such as hydroxy alkyl cellulose, and hydroxymethyl-, hydroxyethyl- or hydroxypropyl-cellulose grafted with a salt of methacryloyl ethyl trimethyl ammonium, methacrylamidopropyl trimethyl ammonium, or dimethyl diallyl ammonium.

(4) cationic polysaccharides such as described in U.S. Pat. Nos. 3,589,578 and 4,031,307, guar gums containing cationic trialkyl ammonium groups, and guar gums modified by a salt, e.g., chloride of 2,3-epoxy propyl trimethyl ammonium.

(5) polymers composed of piperazinyl units and alkylene or hydroxy alkylene divalent radicals with straight or branched chains, possibly interrupted by atoms of oxygen, sulfur, nitrogen, or by aromatic or heterocyclic cycles, as well as the products of the oxidation and/or quaternization of such polymers.

(6) water-soluble polyamino amides prepared by polycondensation of an acid compound with a polyamine. These polyamino amides may be reticulated.

(7) derivatives of polyamino amides resulting from the condensation of polyalkylene polyamines with polycarboxylic acids followed by alkylation by bi-functional agents.

(8) polymers obtained by reaction of a polyalkylene polyamine containing two primary amine groups and at least one secondary amine group with a dioxycarboxylic acid chosen from among diglycolic acid and saturated dicarboxylic aliphatic acids having 3 to 8 atoms of carbon. Such polymers include those described in U.S. Pat. Nos. 3,227,615 and 2,961,347.

(9) cyclopolymers of alkyl diallyl amine or dialkyl diallyl ammonium such as the homopolymer of dimethyl diallyl ammonium chloride and copolymers of diallyl dimethyl ammonium chloride and acrylamide.

(10) quaternary diammonium polymers such as hexadimethrine chloride.

(11) quaternary polyammonium polymers, including, for example, Mirapol® A 15, Mirapol® AD1, Mirapol® AZ 1, and Mirapol® 175 products sold by Miranol.

(12) quaternary polymers of vinyl pyrrolidone and vinyl imidazole such as the products sold under the names Luviquat® FC 905, FC 550, and FC 370 by BASF Corporation.

(13) quaternary polyamines.

(14) reticulated polymers known in the art.

Other cationic polymers that may be used include cationic proteins or hydrolyzed cationic proteins, polyalkyleneimines such as polyethyleneimines, polymers containing vinyl pyridine or vinyl pyridinium units, condensates of polyamines and epichlorhydrins, quaternary polyurethanes, and derivatives of chitin.

The conditioning agent may comprise a protein or hydrolyzed cationic or non-cationic protein. Non-limiting examples of suitable compounds include: hydrolyzed collagens having triethyl ammonium groups, hydrolyzed collagens having trimethyl ammonium and trimethyl stearyl ammonium chloride groups, hydrolyzed animal proteins having trimethyl benzyl ammonium groups (benzyltrimonium hydrolyzed animal protein), hydrolyzed proteins having groups of quaternary ammonium on the polypeptide chain, including at least one C1-C18 alkyl, and blends thereof.

Non-limiting examples of suitable hydrolyzed cationic proteins include: Croquat® L, in which the quaternary ammonium groups include a C₁₂ alkyl group, Croquat® M, in which the quaternary ammonium groups include C₁₀-C₁₈ alkyl groups, Croquat® S in which the quaternary ammonium groups include a C₁₈ alkyl group, Crotein® Q in which the quaternary ammonium groups include at least one C₁-C₁₈ alkyl group, and blends thereof. These products are sold by Croda.

The conditioning agent may also comprise quaternized vegetable protein(s) such as wheat, corn, or soy proteins, non-limiting examples of which include: cocodimonium hydrolyzed wheat protein, laurdimonium hydrolyzed wheat protein, steardimonium hydrolyzed wheat protein, 2-N-stearoyl amino-octadecane-1,3-diol, 2-N-behenoyl amino-octadecane-1,3-diol, 2-N-[2-hydroxy-palmitoyl]-amino-octadecane-1,3-diol, 2-N-stearoyl amino-octadecane-1,3,4-triol, n-stearoyl phytosphingosine, 2-N-palmitoyl amino-hexadecane-1,3-diol, bis-(N-hydroxy ethyl n-cetyl) malonamide, n-(2-hydroxy ethyl)-N-(3-cetoxyl-2-hydroxy propyl) amide of cetylic acid, n-docosanoyl n-methyl-D-glucamine, and blends thereof.

The conditioning agent may also comprise a cationic surfactant such as a salt of a primary, secondary, or tertiary fatty amine, optionally polyoxyalkylenated, a quaternary ammonium salt, a derivative of imadazoline, or an amine oxide. Conditioning agents may also be selected from the group consisting of: mono-, di-, and tri-alkyl amines, and quaternary ammonium compounds with a counterion such as a chloride, a methosulfate, a tosylate, etc. Non-limiting examples of suitable amines include: cetrimonium chloride, dicetyldimonium chloride, behentrimonium methosulfate, and blends thereof.

The conditioning agent may comprise a fatty amine. Non-limiting examples of suitable fatty amines include dodecyl amines, cetyl amines, stearyl amines such as stearamidopropyl dimethylamine, and blends thereof.

The conditioning agent may comprise a fatty acid or derivative(s) thereof. Non-limiting examples of suitable fatty acids include: myristic acid, palmitic acid, stearic acid, behenic acid, oleic acid, linoleic acid, isostearic acid, and blends thereof. The derivatives of fatty acids include carboxylic ester acids including mono-, di-, tri- and tetra-carboxylic acids esters, amides, anhydrides, esteramides, imides, and mixtures of these functional groups.

Also suitable as conditioning agents are the following commercial products:

(1) Aquacat™ Clear Cationic Solution (INCI Name: guar hydroxypropyltrimonium Chloride), n-Hance™ SP-100 (INCI Name: acrylamidopropyl trimonium chloride/acrylamide copolymer), and n-Hance™ cationic guar (INCI Name: guar hydroxypropyltrimonium chloride) from Ashland Specialty Ingredients (Bridgewater, NJ).

(2) Salcare® from BASF Corp.

(3) Softcat™ Polymers from The Dow Chemical Company.

(4) Jaguar® C500, Polycare® Boost, Mackconditioner™ Brite, and Mackine® 301 from Rhodia.

(5) Stepanquat® ML, Stepanquat® GA-90, Ninol®, and Ammonyx® from Stepan Company.

(6) Conditioneze™ 7 and Conditioneze™ NT-20 from Ashland Specialty Ingredients (Bridgewater, NJ).

Of course, mixtures of two or more conditioning agents may be used.

In one non-limiting embodiment, the conditioning agent(s) may be present in an amount from about 0.001% to about 20%. In another non-limiting embodiment, the conditioning agent(s) may be present in an amount from about 0.01% to about 10%. In yet another non-limiting embodiment, the conditioning agent(s) may be present in an amount from about 0.1% to about 3% by weight of the composition.

Personal care compositions may optionally comprise antimicrobial agent(s).

Non-limiting examples of suitable water insoluble, non-cationic antimicrobial agents include: halogenated diphenyl ethers, phenolic compounds including phenol and its homologs, mono and poly-alkyl and aromatic halophenols, resorcinol and its derivatives, bisphenolic compounds and halogenated salicylanilides, benzoic esters, halogenated carbanilides, and blends thereof.

Non-limiting examples of suitable water-soluble antimicrobial agents include: quaternary ammonium salts, bis-biguanide salts, triclosan monophosphate, and blends thereof.

The quaternary ammonium agents include those in which one or two of the substituents on the quaternary nitrogen has a carbon chain length (typically alkyl group) from about 8 to about 20, typically from about 10 to about 18 carbon atoms, while the remaining substituents (typically alkyl or benzyl group) have a lower number of carbon atoms, such as from about 1 to about 7 carbon atoms, typically methyl or ethyl groups.

Non-limiting examples of suitable quaternary ammonium antibacterial agents include: Dodecyl trimethyl ammonium bromide, tetradecylpyridinium chloride, domiphen bromide, n-tetradecyl-4-ethyl pyridinium chloride, dodecyl dimethyl(2-phenoxyethyl)ammonium bromide, benzyl dimethylstearyl ammonium chloride, cetyl pyridinium chloride, quaternized 5-amino-1,3-bis(2-ethyl-hexyl)-5-methyl hexahydropyrimidine, benzalkonium chloride, benzethonium chloride, methyl benzethonium chloride, and blends thereof.

Other antimicrobial compounds are bis[4-(R-amino)-1-pyridinium]alkanes as disclosed in U.S. Pat. No. 4,206,215. Other antimicrobials such as copper salts, zinc salts and/or stannous salts may also be included. Also useful are enzymes, including endoglycosidase, papain, dextranase, mutanase, and blends thereof. Such antimicrobial agents are disclosed in U.S. Pat. Nos. 2,946,725 and 4,051,234. The antimicrobial agents may also comprise chlorhexidine, triclosan, and flavor oils such as thymol. Triclosan and other agents are disclosed in U.S. Pat. Nos. 5,015,466 and 4,894,220.

In non-limiting aspects, one or more preservatives may be included.

Non-limiting examples of suitable preservatives include benzoic acid, sorbic acid, dehydroacetic acid, diazolidinyl ureas, imidazolidinyl ureas, salicylic acid, piroctone olamine, DMDM hydantoin, IPBC (iodopropynyl butylcarbamate), triclosan, bronopol, formaldehyde, isothiazolinones, nitrates/nitrites, parabens, phenoxyethanol, potassium sorbate, sodium benzoate, sulphites, sulphur dioxide, and blends thereof.

In non-limiting aspects, preservative boosters/solvents may be incorporated, non-limiting examples of which include: caprylyl glycol, hexylene glycol, pentylene glycol, ethylhexylglycerin, caprylhydroxamic acid, caprylohydroxamic acid, glyceryl caprylate, and blends thereof.

Polysaccharides, such as gum Arabic, may be included as well.

The compositions may comprise liquid or liquid-like carrier(s) that help to distribute, disperse, and/or dissolve the ingredients.

Non-limiting examples of suitable liquid carriers include water, alcohols, oils, esters, and blends thereof.

The compositions may also be in the form of aqueous or hydro-alcoholic solutions.

The physiological and cosmetically acceptable medium may consist exclusively of water, a cosmetically acceptable solvent, or a blend of water and a cosmetically acceptable solvent, such as a lower alcohol composed of C1 to C4, such as ethanol, isopropanol, t-butanol, n-butanol, alkylene glycols such as propylene glycol, and glycol ethers.

Personal care compositions may comprise vitamin(s), provitamin(s), and/or mineral(s).

Non-limiting examples of suitable vitamins include ascorbic acid (vitamin C), vitamin E, vitamin E acetate, vitamin E phosphate, B vitamins such as B3 and B5, niacin, vitamin A, derivatives thereof, and blends thereof.

Non-limiting examples of suitable provitamins include: panthenol, retinol, and blends thereof.

Non-limiting examples of suitable minerals include: talc, clay, calcium carbonate, silica, kaolin, mica, and blends thereof. Further examples of minerals that may be used in the personal care compositions may be found in a brochure titled Minerals for personal care from Imerys Performance Minerals, the disclosure of which is herein incorporated in its entirety by reference.

Personal care compositions may comprise one or more surfactants. Surfactants serve in solubilizing, dispersing, emulsifying and/or reducing the interfacial tension. Surfactants may be chosen from anionic, nonionic, amphoteric, zwitterionic, or cationic surfactants, or blends thereof.

Anionic surfactants useful herein include the water-soluble salts of alkyl sulfates having from 8 to 20 carbon atoms in the alkyl radical (e.g., sodium alkyl sulfate) and the water-soluble salts of sulfonated monoglycerides of fatty acids having from 8 to 20 carbon atoms. Sodium lauryl sulfate (SLS) and sodium coconut monoglyceride sulfonates are non-limiting examples of anionic surfactants of this type.

Non-limiting examples of suitable anionic surfactants include: sarcosinates, taurates, isethionates, sodium lauryl sulfoacetate, sodium laureth carboxylate, and sodium dodecyl benzenesulfonate. Also suitable are alkali metal or ammonium salts of surfactants such as the sodium and potassium salts of the following: lauroyl sarcosinate, myristoyl sarcosinate, palmitoyl sarcosinate, stearoyl sarcosinate, and oleoyl sarcosinate.

Non-limiting examples of suitable cationic surfactants include: derivatives of aliphatic quaternary ammonium compounds having at least one long alkyl chain containing from about 8 to about 18 carbon atoms, such as, lauryl trimethylammonium chloride, cetyl pyridinium chloride, cetyl trimethylammonium bromide, di-isobutylphenoxyethyl-dimethylbenzylammonium chloride, coconut alkyltrimethylammonium nitrite, cetyl pyridinium fluoride, and blends thereof. Further suitable are quaternary ammonium fluorides having detergent properties such as compounds described in U.S. Pat. No. 3,535,421. Certain cationic surfactants may act as germicides in the compositions disclosed herein.

Nonionic surfactants useful herein include compounds produced by the condensation of alkylene oxide groups (hydrophilic in nature) with an organic hydrophobic compound which may be aliphatic or alkylaromatic in nature.

Non-limiting examples of suitable nonionic surfactants include: poloxamers (sold under the trade name Pluronic® by BASF Corporation), polyethylene oxide condensates of alkyl phenols, products derived from the condensation of ethylene oxide with the reaction product of propylene oxide and ethylene diamine, ethylene oxide condensates of aliphatic alcohols, long chain tertiary amine oxides, long chain tertiary phosphine oxides, long chain dialkyl sulfoxides, and blends thereof.

Non-limiting examples of suitable zwitterionic surfactants include betaines and derivatives of aliphatic quaternary ammonium compounds in which the aliphatic radicals can be straight chain or branched, and which contain an anionic water-solubilizing group, e.g., carboxy, sulfonate, sulfate, phosphate, or phosphonate.

Non-limiting examples of suitable betaines include: decyl betaine or 2-(N-decyl-N,N-dimethylammonio)acetate, coco betaine or 2-(N-coc-N,N-dimethyl ammonio)acetate, myristyl betaine, palmityl betaine, lauryl betaine, cetyl betaine, stearyl betaine, and blends thereof. The amidobetaines are exemplified by cocoamidoethyl betaine, cocoamidopropyl betaine, lauramidopropyl betaine, and the like. The betaines of choice include cocoamidopropyl betaines such as lauramidopropyl betaine. Suitable betaine surfactants are disclosed in U.S. Pat. No. 5,180,577.

Other surfactants such as fluorinated surfactants may also be incorporated within the compositions of the invention.

Also suitable as surfactants are the following commercial products:

(1) Alkanolamides, under the trade names Amidex™ and Schercomid™; amido-amines, under the trade names Katemul™ and Schercodine™; amine oxides, under the trade names Chemoxide™ and Schercamox™; amphoterics, under the trade names Chembetaine™ Schercotaine™ and Schercoteric™; imidazolines, under the trade name Schercozoline™; pearlizing agents, under the trade name Quickpearl™; performance concentrates, under the trade names Sulfochem™ and Chemoryl™; soaps (potassium cocoate and potassium soyate); specialty ethoxylates, under the trade name Chemonic™; specialty quats under the trade names Quatrex™ and Schercoquat™; sulfates, under the trade name Sulfochem™; and sulfosuccinates, under the trade name Chemccinate™ from Lubrizol.

(2) Avaniel, Cremaphore®, Jordapan®, and Pluracare® from BASF Corp.

(3) Miracare® SLB, Mackam® Bab, Mackanate® Ultra SI, Miranol® Ultra, and Miracare® Plaisant from Rhodia.

(4) Stepan® Pearl 2, Stepan® Pearl 4, Stepan® Pearl Series, Neobee® M-20, Stepan® PTC, Amphosol® 2CSF, Steol®, Stepan-Mild® GCC, Stepan® SLL-FB, Stepanol® AM, Stepanol® PB, Alpha-Step® BSS-45, Bio-Terge® 804, Stepan-Mild® L3, Stepan® SLL-FB, Stepan® SSL-CG, and Stepanol® CFAS-70 from Stepan Company.

Also suitable as surfactants are those described in the book Surfactants in Personal Care Products and Decorative Cosmetics, Third Edition, 2006, CRC Press. The disclosure is herein incorporated in its entirety by reference.

Personal care compositions may also be formulated as detergent compositions, such as shampoos, bath gels, and bubble baths. Such compositions comprise water as a liquid carrier. The surfactant or surfactants that form the washing base may be chosen alone or in blends, from known anionic, amphoteric, zwitterionic and/or non-ionic surfactants. The quantity and quality of the washing base must be sufficient to impart a satisfactory foaming and/or detergent value to the final composition. In one non-limiting embodiment, the washing base may be present in an amount from about 4% to about 50% by weight.

Personal care compositions may comprise one or more thickener(s) and/or viscosifier(s).

Non-limiting examples of suitable thickeners and/or viscosifiers include: Acetamide MEA; acrylamide/ethalkonium chloride acrylate copolymer; acrylamide/ethyltrimonium chloride acrylate/ethalkonium chloride acrylate copolymer; acrylamides copolymer; acrylamide/sodium acrylate copolymer; acrylamide/sodium acryloyldimethyltaurate copolymer; acrylates/acetoacetoxyethyl methacrylate copolymer; acrylates/beheneth-25 methacrylate copolymer; acrylates/C10-C30 alkyl acrylate crosspolymer; acrylates/ceteth-20 itaconate copolymer; acrylates/ceteth-20 methacrylate copolymer; acrylates/laureth-25 methacrylate copolymer; acrylates/palmeth-25 acrylate copolymer; acrylates/palmeth-25 itaconate copolymer; acrylates/steareth-50 acrylate copolymer; acrylates/steareth-20 itaconate copolymer; acrylates/steareth-20 methacrylate copolymer; acrylates/stearyl methacrylate copolymer; acrylates/vinyl isodecanoate crosspolymer; acrylic acid/acrylonitrogens copolymer; adipic acid/methyl DEA crosspolymer; agar; agarose; Alcaligenes polysaccharides; algin; alginic acid; almondamide DEA; almondamidopropyl betaine; aluminum/magnesium hydroxide stearate; ammonium acrylates/acrylonitrogens copolymer; ammonium acrylates copolymer; ammonium acryloyldimethyltaurate/vinyl formamide copolymer; ammonium acryloyldimethyltaurate/VP copolymer; ammonium alginate; ammonium chloride; ammonium polyacryloyldimethyl taurate; ammonium sulfate; amylopectin; apricotamide DEA; apricotamidopropyl betaine; arachidyl alcohol; arachidyl glycol; Arachis hypogaea (peanut) flour; ascorbyl methylsilanol pectinate; Astragalus gummifer gum; attapulgite; Avena sativa (oat) kernel flour; avocadamide DEA; avocadamidopropyl betaine; azelamide MEA; babassuamide DEA; babassuamide MEA; babassuamidopropyl betaine; behenamide DEA; behenamide MEA; behenamidopropyl betaine; behenyl betaine; bentonite; butoxy chitosan; Caesalpinia spinosa gum; calcium alginate; calcium carboxymethyl cellulose; calcium carrageenan; calcium chloride; calcium potassium carbomer; calcium starch octenylsuccinate; C20-40 alkyl stearate; canolamidopropyl betaine; capramide DEA; capryl/capramidopropyl betaine; carbomer; carboxybutyl chitosan; carboxymethyl cellulose acetate butyrate; carboxymethyl chitin; carboxymethyl chitosan; carboxymethyl dextran; carboxymethyl hydroxyethylcellulose; carboxymethyl hydroxypropyl guar; carnitine; cellulose acetate propionate carboxylate; cellulose gum; Ceratonia siliqua gum; cetearyl alcohol; cetyl alcohol; cetyl babassuate; cetyl betaine; cetyl glycol; cetyl hydroxyethylcellulose; chimyl alcohol; cholesterol/HDIpullulan copolymer; cholesteryl hexyl dicarbamate pullulan; citrus aurantium dulcis (orange) peel extract; cocamide DEA; cocamide MEA; cocamide MIPA; cocamidoethyl betaine; cocamidopropyl betaine; cocamidopropyl hydroxysultaine; coco-betaine; coco-hydroxysultaine; coconut alcohol; coco/oleamidopropyl betaine; coco-Sultaine; cocoyl sarcosinamide DEA; cornamide/cocamide DEA; cornamide DEA; croscarmellose; crosslinked Bacillus/glucose/sodium glutamate ferment; Cyamopsis tetragonoloba (guar) gum; decyl alcohol; decyl betaine; dehydroxanthan gum; dextrin; dibenzylidene sorbitol; diethanolaminooleamide DEA; diglycol/CHDM/isophthalates/SIP copolymer; dihydroabietyl behenate; dihydrogenated tallow benzylmonium hectorite; dihydroxyaluminum aminoacetate; dimethicone/PEG-10 crosspolymer; dimethicone/PEG-15 crosspolymer; dimethicone propyl PG-betaine; dimethylacrylamide/acrylic acid/polystyrene ethyl methacrylate copolymer; dimethylacrylamide/sodium acryloyldimethyltaurate crosspolymer; disteareth-100 IPDI; DMAPA acrylates/acrylic acid/acrylonitrogens copolymer; erucamidopropyl hydroxysultaine; ethylene/sodium acrylate copolymer; gelatin; gellan gum; glyceryl alginate; Glycine soja (soybean) flour; guar hydroxypropyltrimonium chloride; hectorite; hyaluronic acid; hydrated silica; hydrogenated potato starch; hydrogenated tallow; hydrogenated tallowamide DEA; hydrogenated tallow betaine; hydroxybutyl methylcellulose; hydroxyethyl acrylate/sodium acryloyldimethyl taurate copolymer; hydroxyethylcellulose; hydroxyethyl chitosan; hydroxyethyl ethylcellulose; hydroxyethyl stearamide-MIPA; hydroxylauryl/hydroxymyristyl betaine; hydroxypropylcellulose; hydroxypropyl chitosan; hydroxypropyl ethylenediamine carbomer; hydroxypropyl guar; hydroxypropyl methylcellulose; hydroxypropyl methylcellulose stearoxy ether; hydroxypropyl starch; hydroxypropyl starch phosphate; hydroxypropyl xanthan gum; hydroxystearamide MEA; isobutylene/sodium maleate copolymer; isostearamide DEA; isostearamide MEA; isostearamide mIPA; isostearamidopropyl betaine; lactamide MEA; lanolinamide DEA; lauramide DEA; lauramide MEA; lauramide MIPA; lauramide/myristamide DEA; lauramidopropyl betaine; lauramidopropyl hydroxysultaine; laurimino bispropanediol; lauryl alcohol; lauryl betaine; lauryl hydroxysultaine; lauryl/myristyl glycol hydroxypropyl ether; lauryl sultaine; lecithinamide DEA; linoleamide DEA; linoleamide MEA; linoleamide MIPA; lithium magnesium silicate; lithium magnesium sodium silicate; macrocystis pyrifera (kelp); magnesium alginate; magnesium/aluminum/hydroxide/carbonate; magnesium aluminum silicate; magnesium silicate; magnesium trisilicate; methoxy PEG-22/dodecyl glycol copolymer; methylcellulose; methyl ethylcellulose; methyl hydroxyethylcellulose; microcrystalline cellulose; milkamidopropyl betaine; minkamide DEA; minkamidopropyl betaine; MIPA-myristate; montmorillonite; Moroccan lava clay; myristamide DEA; myristamide MEA; myristamide MIPA; myristamidopropyl betaine; myristamidopropyl hydroxysultaine; myristyl alcohol; myristyl betaine; natto gum; nonoxynyl hydroxyethylcellulose; oatamide MEA; oatamidopropyl betaine; octacosanyl glycol isostearate; octadecene/MA copolymer; oleamide DEA; oleamide MEA; oleamide MIPA; oleamidopropyl betaine; oleamidopropyl hydroxysultaine; oleyl betaine; olivamide DEA; olivamidopropyl betaine; oliveamide MEA; palmamide DEA; palmamide MEA; palmamide MIPA; palmamidopropyl betaine; palmitamide DEA; palmitamide MEA; palmitamidopropyl betaine; palm kernel alcohol; palm kernelamide DEA; palm kernelamide MEA; palm kernelamide MIPA; palm kernelamidopropyl betaine; peanutamide MEA; peanutamide MIPA; pectin; PEG-800; PEG-crosspolymer; PEG-150/decyl alcohol/SMDI copolymer; PEG-175 diisostearate; PEG-190 distearate; PEG-15 glyceryl tristearate; PEG-140 glyceryl tristearate; PEG-240/HDI copolymer bis-decyltetradeceth-20 ether; PEG-100/IPDI copolymer; PEG-180/laureth-50/™MG copolymer; PEG-10/lauryl dimethicone crosspolymer; PEG-15/lauryl dimethicone crosspolymer; PEG-2M; PEG-5M; PEG-7M; PEG-9M; PEG-14M; PEG-20M; PEG-23M; PEG-25M; PEG-45M; PEG-65M; PEG-90M; PEG-115M; PEG-160M; PEG-180M; PEG-120 methyl glucose trioleate; PEG-180/octoxynol-40/™MG copolymer; PEG-150 pentaerythrityl tetrastearate; PEG-4 rapeseedamide; PEG-150/stearyl alcohol/SMDI copolymer; Phaseolus angularis seed powder; Polianthes tuberosa extract; polyacrylate-3; polyacrylic acid; polycyclopentadiene; polyether-1; polyethylene/isopropyl maleate/MA copolyol; polyglyceryl-3 disiloxane dimethicone; polyglyceryl-3 polydimethylsiloxyethyl dimethicone; polymethacrylic acid; polyquaternium-52; polyvinyl alcohol; potassium alginate; potassium aluminum polyacrylate; potassium carbomer; potassium carrageenan; potassium chloride; potassium palmate; potassium polyacrylate; potassium sulfate; potato starch modified; PPG-2 cocamide; PPG-1 hydroxyethyl caprylamide; PPG-2 hydroxyethyl cocamide; PPG-2 hydroxyethyl coco/isostearamide; PPG-3 hydroxyethyl soyamide; PPG-14 laureth-60 hexyl dicarbamate; PPG-14 laureth-60 isophoryl dicarbamate; PPG-14 palmeth-60 hexyl dicarbamate; propylene glycol alginate; PVP/decene copolymer; PVP montmorillonite; Pyrus cydonia seed; Pyrus malus (apple) fiber; rhizobian gum; ricebranamide DEA; ricinoleamide DEA; ricinoleamide MEA; ricinoleamide MIPA; ricinoleamidopropyl betaine; ricinoleic acid/adipic acid/AEEA copolymer; Rosa multiflora flower wax; Sclerotium gum; sesamide DEA; sesamidopropyl betaine; sodium acrylate/acryloyldimethyl taurate copolymer; sodium acrylates/acrolein copolymer; sodium acrylates/acrylonitrogens copolymer; sodium acrylates copolymer; sodium acrylates crosspolymer; sodium acrylate/sodium acrylamidomethylpropane sulfonate copolymer; sodium acrylates/vinyl isodecanoate crosspolymer; sodium acrylate/vinyl alcohol copolymer; sodium carbomer; sodium carboxymethyl chitin; sodium carboxymethyl dextran; sodium carboxymethyl beta-glucan; sodium carboxymethyl starch; sodium carrageenan; sodium cellulose sulfate; sodium chloride; sodium cyclodextrin sulfate; sodium hydroxypropyl starch phosphate; sodium isooctylene/MA copolymer; sodium magnesium fluorosilicate; sodium oleate; sodium palmitate; sodium palm kernelate; sodium polyacrylate; sodium polyacrylate starch; sodium polyacryloyldimethyl taurate; sodium polygamma-glutamate; sodium polymethacrylate; sodium polystyrene sulfonate; sodium silicoaluminate; sodium starch octenylsuccinate; sodium stearate; sodium stearoxy PG-hydroxyethylcellulose sulfonate; sodium styrene/acrylates copolymer; sodium sulfate; sodium tallowate; sodium tauride acrylates/acrylic acid/acrylonitrogens copolymer; sodium tocopheryl phosphate; Solanum tuberosum (potato) starch; soyamide DEA; soyamidopropyl betaine; starch/acrylates/acrylamide copolymer; starch hydroxypropyltrimonium chloride; stearamide AMP; stearamide DEA; stearamide DEA-distearate; stearamide DIBA-stearate; stearamide MEA; stearamide MEA-stearate; stearamide MIPA; stearamidopropyl betaine; steareth-60 cetyl ether; steareth-100/PEG-136/HDI copolymer; stearyl alcohol; stearyl betaine; Sterculia urens gum; synthetic fluorphlogopite; tallamide DEA; tallow alcohol; tallowamide DEA; tallowamide MEA; tallowamidopropyl betaine; tallowamidopropyl hydroxysultaine; tallowamine oxide; tallow betaine; tallow dihydroxyethyl betaine; tamarindus indica seed gum; tapioca starch; TEA-alginate; TEA-carbomer; TEA-hydrochloride; trideceth-2 carboxamide MEA; tridecyl alcohol; triethylene glycol dibenzoate; trimethyl pentanol hydroxyethyl ether; Triticum vulgare (wheat) germ powder; Triticum vulgare (wheat) kernel flour; Triticum vulgare (wheat) starch; tromethamine acrylates/acrylonitrogens copolymer; tromethamine magnesium aluminum silicate; undecyl alcohol; undecylenamide DEA; undecylenamide MEA; undecylenamidopropyl betaine; welan gum; wheat germamide DEA; wheat germamidopropyl betaine; xanthan gum; yeast beta-glucan; yeast polysaccharides; Zea mays (corn) starch; and blends thereof.

Also suitable as thickeners and/or viscosifiers are the following commercial products:

(1) Aqualon™ carboxymethylcellulose, Benecel™ methylcellulose and hydroxypropyl methylcellulose, Blanose™ sodium carboxymethylcellulose, Klucel™ hydroxypropylcellulose, Natrosol™ hydroxyethylcellulose, Natrosol™ Plus and PolySurf™ cetyl modified hydroxyethylcellulose, n-Hance™ cationic guar, n-Hance™ HP Series hydroxypropyl guar, n-Hance™ SP-100 conditioning polymer, and Supercol™ guar gum from Ashland Specialty Ingredients (Bridgewater, NJ).

(2) Carbopol® Polymers, Fixate™ PLUS Polymer, Glucamate™ Thickeners, Amidex™ Surfactants, Chembetaine™ Surfactants, Chemoxide™ Surfactants, Chemonic™ Surfactants, Chemccinate™ Surfactants, Amidex™ BC-24 Surfactant, Chemoryl™ LB-30 Surfactant, Novethix™ L-10 Polymer, Ceralan™ Lanolin Product, Pemulen™ TR-1 Polymeric Emulsifier, Pemulen™ TR-2 Polymeric Emulsifier, Hydramol™ PGPD Ester, Schercodine™ M Amido-Amine, Schercodine™ P Amido-Amine, Schercomid™ Diethanolamides from The Lubrizol Corporation.

(3) Salcare® and Luvigel® from BASF Corporation.

(4) Aculyn™ 22, Aculyn™ 28, Aculyn™ 33, Aculyn™ 38, and Aculyn™ 44 from The Dow Chemical Company.

(5) Ammonyx® C and Stepan-Mild® GCC from Stepan Company.

(6) Stabileze™, Rapithix™ A-60, Rapithix™ A-100, Ultrathix™ β-100, Lubrajel™ and FlexiThix™ from Ashland Specialty Ingredients (Bridgewater, NJ).

Also suitable as a thickener/rheology modifier are lightly- to moderately-crosslinked polyvinylpyrrolidones. Disclosures of these polymers are provided in the following publications, each of which is herein incorporated in its entirety by reference: U.S. Pat. Nos. 5,073,614; 5,312,619; 5,139,770; 5,716,634; 5,470,884; 5,759,524; 5,997,887; 6,024,942; as well as international application PCT/US10/26973, PCT/US10/26976, PCT/US10/26940, PCT/US11/32993, and PCT/US11/34515.

Personal care compositions may comprise natural extracts and/or natural products. Extensive details on natural products that can be used in personal care compositions is provided in book chapter “Chemistry of Cosmetics, Comprehensive Natural Products II” in Chemistry and Biology; volume 3, 2010.

Also contemplated are additional personal care compositions that may comprise the polymers described herein. Disclosures on such compositions may be found in the publications listed below, each of which is herein incorporated in its entirety by reference: (1) Prototype Compositions—Personal Care Products (2009) from Xiameter, Dow Corning. (2) Sun care compositions under the category “Refreshing Sun”, “Younger Sun”, “Sun for Men”, and “Sunny Glow” from Dow Corning. (3) Cosmetic Nanotechnology, Polymers and Colloids in Cosmetics, 2007, ACS Symposium Series. (4) Review Paper: Lipid nanoparticles (SLN, NLC) in cosmetic and pharmaceutical dermal products, International Journal of Pharmaceutics, Volume 366, 2009.

Non-limiting examples of properties that may be beneficially modified by the block copolymers and compositions disclosed herein are solution viscosity, rheology, thickening, film formation, lubricity, gloss, adhesion, impact resistance, fluid snap, film brittleness, film toughness, coating hardness, water resistance, tack, surface gloss and shine, surface tension, wetting, foaming and foam stabilization, tensile strength, solvency, solubilization speed, compatibility, bio-adhesion, particulate suspension, particulate dispersive properties, dispersive properties, delivery of hydrophobic compositions, formulation stabilization, suspension stability, dispersion stability, flexibility, chemical resistance, abrasion resistance, penetration, hydrolytic degradability, biodegradability, biocompatibility, and combinations thereof.

### Methods of Synthesis

RAFT polymerization is one of the most robust and versatile methods for providing living characteristics to radical polymerization. With appropriate selection of the RAFT agent for the monomers and reaction conditions, it is applicable to majority of monomers subject to radical polymerization. The process can be used in the synthesis of well-defined homo-, gradient, diblock, triblock, and star polymers and more complex architectures, which include microgels and polymer brushes.

When preparing, for example, a block copolymer in the presence of the control agent, the end of the growing block is provided with a specific functionality that controls the growth of the block by means of reversible free radical deactivation. The functionality at the end of the block is of such a nature that it can reactivate the growth of the block in a second and/or third stage of the polymerization process with other ethylenically unsaturated monomers providing a covalent bond between, for example, a first and second block [A] and [B] and with any further optional blocks.

Further details on the chemistry of synthesis of block copolymers by RAFT processes may be found in the following publications, each of which is herein incorporated in its entirety by reference: Polymer, 2008, volume 49, 1079-1131; Chemical Society Reviews, 2014, volume 43, 496-505; Macromolecules, 1998, volume 31, 5559-5562; and Polymer, 2013, volume 54, 2011-2019.

In one non-limiting embodiment, the block copolymer according to the disclosed and/or claimed inventive concepts is obtained by RAFT-mediated controlled radical polymerization. In one non-limiting embodiment, the reversible transfer agents may be one or more compounds selected from the group consisting of dithioesters, thioether-thiones, trithiocarbonates, dithiocarbamates, xanthates and mixtures thereof.

The block copolymers according to the disclosed and/or claimed inventive concept(s) may be prepared according to the examples set out below. These examples are presented herein for purposes of illustration of the disclosed and/or claimed inventive concept(s) and are not intended to be limiting, for example, the preparations of the polymers. In the examples, the following abbreviations are used:
CL: ε-caprolactone
PCL: poly(F-caprolactone)
CEPA: 4-cyano-4-(ethylsulfanylthiocarbonyl)sulfanylpentanoic acid
TTC: Trithiocarbonate
AVCA: 4,4′-Azobis(4-cyanopentanoic acid)
DCC: N,N′-dicyclohexylcarbodiimide
DMAC: N,N′-dimethylacrylamide
PDMAC: polyDMAC
TBD: triazabicyclodecene
DMAP: 4-(dimethylamino)pyridine
DMF: N,N′-Dimethylformamide
NMR: Nuclear magnetic resonance
CTA: Chain transfer agent
DP: Degree of polymerization
GPC: Gel permeation chromatography
UV: Ultraviolet
TEM: Transmission electron microscopy
DLS: Dynamic light scattering
Mn: Number-average molecular weight
MW: Weight-average molecular weight

### EXAMPLES

All reagents were used as received, unless stated otherwise. ACVA (98%), DCC (99%), DMAC (99%), anhydrous magnesium sulfate, deuterated water (99.9%), lithium bromide, TBD, potassium dihydrogen phosphate, calcium hydride, F-caprolactone and benzyl alcohol were purchased from Sigma-Aldrich (Dorset, UK). The latter two reagents were dried over calcium hydride and distilled before use. Ammonia solution (28%) and DMAP were purchased from Alfa Aesar (Heysham, UK). DMF was purchased from VWR (Leicestershire, UK). Methanol, ammonium chloride, Oxoid™ phosphate buffered saline tablets and hydrochloric acid (38%) were purchased from Fisher Scientific (Loughborough, UK). Benzoic acid was purchased from Fluorochem Limited (Hadfield, UK). Deuterated dichloromethane (99.8%) was purchased from Goss Scientific Instruments Ltd. (Cheshire, UK). Anhydrous dichloromethane and toluene were obtained from an in-house Grubbs purification solvent system. Dihydroxy-capped poly(F-caprolactone) was donated by Ingevity (North Charleston, South Carolina, USA). Azoxystrobin was kindly provided by Syngenta (Jealotts Hill, UK). The antifoaming agent, silicone SAG1572, was purchased from Momentive (Germany), and 1.0 mm zirconium aluminum oxide beads were purchased from Sigmund-Lindner (Germany). CEPA was prepared using a known literature protocol. Deionized water was obtained from an Elgastat Option 3A water purification unit with a resistivity of 15 MΩ cm.

### Synthesis of Monohydroxy-Capped PCL

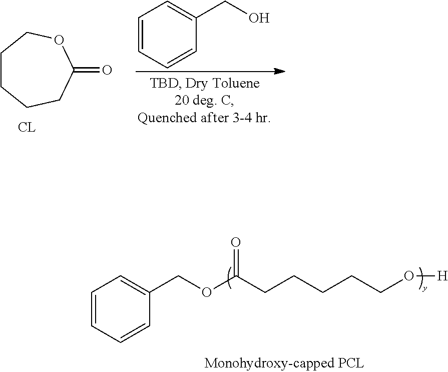

The polymerization of F-caprolactone was conducted based on a synthesis protocol reported in the literature. For example, β-caprolactone (10.77 g, 94.3 mmol) was added to a flame-dried Schlenk flask charged with TBD (65.6 mg, 0.472 mmol), benzyl alcohol (0.15 g, 1.39 mmol; target DP=68) and toluene (46 mL). This reaction mixture was stirred at 20° C. under a nitrogen atmosphere and the ensuing ring-opening polymerization was quenched after 4 h by addition of benzoic acid. The resulting solution was precipitated into excess ice-cold methanol and filtered under vacuum to afford a monohydroxy-capped PCL with a mean DP of 42 (PCL₄₂-OH, final caprolactone conversion=62%). End-group analysis by ¹H NMR spectroscopy was used to estimate the mean DP for each monohydroxy-capped PCL precursor by comparing the methylene unit assigned to the initiator to the two methylene ester protons of the PCL. For analogous syntheses targeting alternative PCL DPs, the monomer, catalyst, solvent, and initiator quantities were adjusted accordingly (see Table 1).

### Synthesis of Trithiocarbonate-Capped Monofunctional PCL Precursors

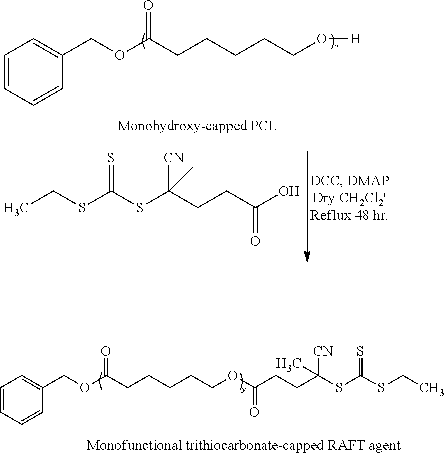

All glassware were dried in a 200° C. oven for 24 h prior to use. DMAP (0.024 g, 0.194 mmol), DCC (0.714 g, 3.46 mmol), monohydroxy-capped PCL₄₂ (5.00 g, 1.02 mmol) and CEPA (0.455 g, 1.73 mmol) were weighed into four separate dry 28 mL vials, sealed with rubber septa, and further dried in a vacuum oven for 2 h at 35° C. A minimal amount of anhydrous CH₂Cl₂ was added to these four vials using a syringe/needle to dissolve each reagent. The three CH₂Cl₂ solutions containing CEPA, monohydroxy-capped PCL₄₂ and DMAP respectively were then transferred via syringe/needle into a 100 mL two-necked round-bottom flask fitted with a condenser, charged with a magnetic stirrer bar, and sealed with a rubber septum. This flask was then immersed in an ice bath and the CH₂Cl₂ solution containing DCC was added dropwise via syringe/needle. The reaction mixture was heated to reflux while purging with dry N₂ gas and then refluxed for 48 h. The reaction mixture was cooled to 20° C., filtered to remove the insoluble N,N′-dicyclohexylurea by-product, and the solution was concentrated to approximately 2 mL under vacuum. The crude PCL₄₂-trithiocarbonate was purified by precipitation into excess ice-cold methanol, filtered under vacuum and washed copiously with methanol to remove impurities. GPC analysis (using a UV detector set at 305 nm) confirmed that the purified PCL₄₂-trithiocarbonate precursor contained no residual CEPA. ¹H NMR spectroscopy was used to assess the mean degree of esterification via end-group analysis, comparing the integrated proton signal assigned to the methyl group of the RAFT agent with the unique PCL backbone signals. For analogous syntheses in which the mean DP (21, 29 and 42) of the monofunctional PCL precursor was varied, the reagent quantities were adjusted accordingly as shown in Table 2.

### Synthesis of the Bifunctional Trithiocarbonate-Capped PCL Precursor

All glassware was dried in a 200° C. oven for 24 h prior to use. DMAP (0.23 g, 1.90 mmol), DCC (3.50 g, 17.0 mmol), dihydroxy-capped PCL₁₆ (5.00 g, 2.77 mmol) and CEPA (2.23 g, 8.50 mmol) were weighed into four separate dry 28 mL vials, sealed with rubber septa, and further dried in a vacuum oven for 2 h at 35° C. A minimal amount of anhydrous CH₂C₂ was added to the four vials using a syringe/needle to dissolve each reagent. The three CH₂Cl₂ solutions containing CEPA, dihydroxy-capped PCL₁₆ and DMAP respectively were then transferred via syringe/needle into a 100 mL two-necked round-bottom flask fitted with a condenser, charged with a magnetic stirrer bar, and sealed with a rubber septum. This flask was then immersed in an ice bath and the CH₂Cl₂ solution containing DCC was added dropwise via syringe/needle. The reaction mixture was heated to reflux while purging with dry N₂ gas and then refluxed for 48 h. The reaction mixture was cooled to 20° C., filtered to remove the insoluble N,N′-dicyclohexylurea by-product, and the solution was concentrated to approximately 2 mL under vacuum. The crude TTC-PCL₁₆-TTC was purified by precipitation into excess ice-cold methanol, filtered under vacuum and washed copiously with methanol to remove impurities. GPC analysis (using a UV detector set at 305 nm) confirmed that the purified TTC-PCL₁₆-TTC precursor contained no residual CEPA. ¹H NMR spectroscopy was used to assess the mean degree of esterification via end-group analysis, comparing the integrated proton signal assigned to the methyl group of the RAFT agent with the unique PCL backbone signals.

RAFT Polymerization of DMAC in the Bulk Using TTC-PCL₁₆-TTC with Subsequent Dilution with Water at an Intermediate DMAC Conversion

A 28 mL vial was charged with TTC-PCL₁₆-TTC (0.10 g, 0.043 mmol), DMAC (0.68 g, 6.87 mmol, target DP=80), ACVA (4.80 mg, 0.017 mmol, [TTC]/[ACVA] molar ratio=5.0) and a magnetic stirrer bar and sealed with a rubber septum. This vial was placed in an ice bath and deoxygenated with a stream of dry N₂ gas for 30 min. The vial was then allowed to warm to room temperature for 10 min before being immersed in an oil bath set at 80° C. The reaction mixture was stirred magnetically and monitored by visual inspection. As soon as the reaction mixture became much more viscous after 7.5 min, deoxygenated deionized water (7.07 mL, preheated to 80° C., targeting 10% w/w solids) was added using a degassed syringe/needle. At this point, the reaction vial was removed from the oil bath and subjected to vortex mixing for 2 min to ensure a homogeneous solution, then re-immersed in the oil bath. At this time point, the reaction mixture was sampled and ¹H NMR spectroscopy analysis indicated an instantaneous DMAC conversion of 37% (PDMAC with DP~30). The DMAC polymerization was allowed to proceed for 16 h prior to quenching by exposing the reaction mixture to air while cooling to 20° C. Occasionally, a small amount of gel formed at the top of the vial but this could be redispersed into the solution by vortex mixing. A final DMAC conversion of more than 99% was indicated by ¹H NMR studies. For analogous syntheses in which the initial solids content, target PDMAC DP and both type and nature of the PCL-based RAFT agent were varied, the reagent quantities and volume of added water were adjusted accordingly (see Tables 3 and 4).

RAFT Polymerization of DMAC in the Bulk Using PCL₄₂-TTC with Subsequent Dilution with Water at an Intermediate DMAC Conversion

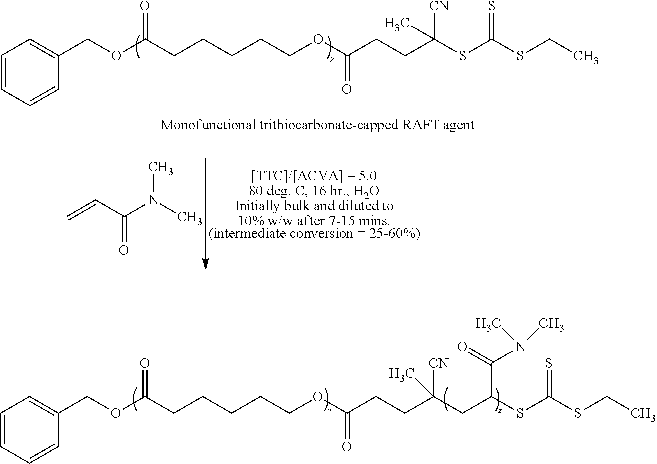

A 28 mL vial was charged with PCL₄₂-TTC (0.10 g, 0.019 mmol), DMAC (0.23 g, 2.32 mmol, target DP=120), ACVA (1.1 mg, 0.004 mmol, [TTC]/[ACVA] molar ratio=5.0) and a magnetic stirrer bar and sealed with a rubber septum. This vial was placed in an ice bath and deoxygenated with a stream of dry N₂ gas for 30 min. The vial was then allowed to warm to room temperature for 10 min before being immersed in an oil bath set at 80° C. The reaction mixture was stirred magnetically and monitored by visual inspection. As soon as the reaction mixture became much more viscous after 14 min, deoxygenated deionized water (2.98 mL, preheated to 80° C., targeting 10% w/w solids) was added using a degassed syringe/needle. At this point, the reaction vial was removed from the oil bath and subjected to vortex mixing for 2 min to ensure a homogeneous solution, then re-immersed in the oil bath. At this time point, the reaction mixture was sampled and ¹H NMR spectroscopy analysis indicated an instantaneous DMAC conversion of 60% (PDMAC with DP~72). The DMAC polymerization was allowed to proceed for 16 h prior to quenching by exposing the reaction mixture to air while cooling to 20° C. Occasionally, a small amount of gel formed at the top of the vial but this could be redispersed into the solution by vortex mixing. A final DMAC conversion of more than 99% was indicated by ¹H NMR studies. For analogous syntheses in which the initial solids content, target PDMAC DP and both type and nature of the PCL-based RAFT agent were varied, the reagent quantities and volume of added water were adjusted accordingly (see Table 3).

RAFT Polymerization of DMAC in 80% w/w Solids Aqueous Solution Using TTC-PCL₁₆-TTC with Subsequent Dilution with Water at an Intermediate DMAC Conversion

A 28 mL vial was charged with TTC-PCL₁₆-TTC (0.10 g, 0.043 mmol), DMAC (0.68 g, 6.87 mmol, target DP=80), ACVA (4.80 mg, 0.017 mmol, [TTC]/[ACVA] molar ratio=5.0), deionized water (0.20 mL, 80% w/w solids) and a magnetic stirrer bar and sealed with a rubber septum. This vial was placed in an ice bath and deoxygenated with a stream of dry N₂ gas for 30 min. The vial was then allowed to warm to room temperature for 10 min before being immersed in an oil bath set at 80° C. The reaction mixture was stirred magnetically and monitored by visual inspection. As soon as the reaction mixture became much more viscous after 10 min, deoxygenated deionized water (6.87 mL, preheated to 80° C., targeting 10% w/w solids) was added using a degassed syringe/needle. At this point, the reaction vial was removed from the oil bath and subjected to vortex mixing for 2 min to ensure a homogeneous solution, then reimmersed in the oil bath. At this time point, the reaction mixture was sampled and ¹H NMR spectroscopy analysis indicated an instantaneous DMAC conversion of 59% (PDMAC DP~47). The DMAC polymerization was allowed to proceed for 16 h prior to quenching by exposing the reaction mixture to air while cooling to 20° C. Occasionally, a small amount of gel formed at the top of the vial but this could be redispersed into the solution by vortex mixing. A final DMAC conversion of more than 99% was indicated by ¹H NMR studies. For analogous syntheses in which the initial solids content, target PDMAC DP and both type and nature of the PCL-based RAFT agent were varied, the reagent quantities and volume of added water were adjusted accordingly (see Table 5).

RAFT Polymerization of DMAC in 80% w/w Solids Aqueous Solution Using PCL₄₂-TTC with Subsequent Dilution with Water at an Intermediate DMAC Conversion

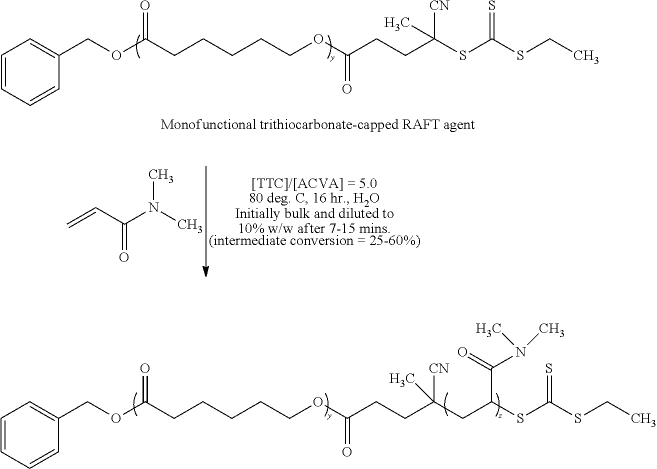

A 28 mL vial was charged with PCL₄₂-TTC (0.10 g, 0.019 mmol), DMAC (0.23 g, 2.32 mmol, target DP=120), ACVA (1.1 mg, 0.004 mmol, [TTC]/[ACVA] molar ratio=5.0), deionized water (0.08 mL, 80% w/w solids) and a magnetic stirrer bar and sealed with a rubber septum. This vial was placed in an ice bath and deoxygenated with a stream of dry N₂ gas for 30 min. The vial was then allowed to warm to room temperature for 10 min before being immersed in an oil bath set at 80° C. The reaction mixture was stirred magnetically and monitored by visual inspection. As soon as the reaction mixture became much more viscous after 7 min, deoxygenated deionized water (2.90 mL, preheated to 80° C., targeting 10% w/w solids) was added using a degassed syringe/needle. At this point, the reaction vial was removed from the oil bath and subjected to vortex mixing for 2 min to ensure a homogeneous solution, then re-immersed in the oil bath. At this time point, the reaction mixture was sampled and ¹H NMR spectroscopy analysis indicated an instantaneous DMAC conversion of 21% (PDMAC DP~25). The DMAC polymerization was allowed to proceed for 16 h prior to quenching by exposing the reaction mixture to air while cooling to 20° C. A final DMAC conversion of more than 99% was indicated by ¹H NMR studies. For analogous syntheses in which the initial solids content, target PDMAC DP and both type and nature of the PCL-based RAFT agent were varied, the reagent quantities and volume of added water were adjusted accordingly (see Table 5).

### Hydrolytic Degradation of Block Copolymers in Aqueous Solution

A series of aqueous solutions were prepared as follows. Potassium dihydrogen phosphate (10.0 g, 0.073 mol) was dissolved in deionized water (80 mL). Then the solution pH was adjusted with 0.1 M HCl and made up to 100 mL using further deionized water to provide a final solution pH of 2.9. Ammonium chloride (6.80 g, 0.13 mol) was dissolved in 28% aqueous ammonia solution (100 mL) to afford a final solution pH of 10.8. A single Oxoid PBS tablet was dissolved in deionized water (100 mL) and 0.1 M HCl was used to adjust the solution pH to pH 7.4. A 10% w/w aqueous dispersion of PDMAC₅₀-PCL₁₆-PDMAC₅₀ nanoparticles was diluted to 1.0% w/w using each of the above aqueous solutions in turn. The resulting three aqueous dispersions were stirred at 37° C. for four weeks and sampled periodically for GPC and DLS analysis. The same protocol was employed to study the hydrolytic degradation of aqueous dispersions of PCL₂₁-PDMAC₇₀ and PCL₄₂-PDMAC₁₂₀ nanoparticles.

TABLE 1
Summary of reagent quantities used for the ring-opening polymerization of CL in dry toluene
at 20 ° C Each reaction was quenched after the stated reaction time using benzoic acid.

| | Polymer | Benzy1 | | | | Quench | Final CL |
|---|---|---|---|---|---|---|---|
| N | Composition | Alcohol | ε-Caprolactone | TBD | Toluene | Time | Conversion |
| 1 | PCL₂₁-OH | 150 mg | 4.43 g | 27.0 mg | 19 mL | 3 h | 75% |
| | | (1.39 mmol) | (38.8 mmol) | (0.19 mmol) | | | |
| 2 | PCL₂₉-OH | Same as in | 7.76 g | 47.3 mg | 33 mL | 3 h | 59% |
| | | N #1 | (68.0 mmol) | (0.34 mmol) | | | |
| 3 | PCL₄₂-OH | Same as in | 10.8 g | 65.6 mg | 46 mL | 4 h | 62% |
| | | N #1 | (94.3 mmol) | (0.47 mmol) | | | |

TABLE 2
Summary of reagent quantities used for the DCC/DMAP
catalyzed esterification of PCL precursors using
the CEPA RAFT agent. Esterification was performed under nitrogen
in refluxing dry CH₂Cl₂.

| | PCL | | | | |
|---|---|---|---|---|---|
| N | Precursor | PCL | CEPA | DMAP | DCC |
| 1 | HO- | 5.00 g | 2.37 g | 247 mg | 3.72 g |
| | PCL₁₆-OH | (2.66 mmol) | (9.03 mmol) | (2.02 mmol) | (18.0 mmol) |
| 2 | PCL₂₁-OH | 5.00 g | 0.89 g | 46.4 mg | 1.40 g |
| | | (2.00 mmol) | (3.39 mmol) | (0.38 mmol) | (6.77 mmol) |
| 3 | PCL₂₉-OH | 5.00 g | 0.63 g | 32.9 mg | 0.99 g |
| | | (1.42 mmol) | (2.41 mmol) | (0.27 mmol) | (4.80 mmol) |
| 4 | PCL₄₂-OH | 5.00 mg | 0.46 g | 23.7 mg | 0.71 g |
| | | (0.10 mmol) | (1.73 mmol) | (0.19 mmol) | (3.46 mmol) |

TABLE 3
Summary of reagent quantities used for the initial bulk polymerization of
DMAC using either a TTC-PCL₁₆-TTC or a PCL_{y}-TTC precursor,
with subsequent dilution via addition of deoxygenated deionized water.

| | Polymer | | | | | Dilution | Intermediate |
|---|---|---|---|---|---|---|---|
| N | composition | (TTC-)PCL-TTC | DMAC | AVCA | Water | Time | conversion |
| 1 | PD₈₀-PCL₁₆- | 0.10 g | 0.68 g | 4.8 mg | 7.07 | 7.5 min | 37% |
| | PD₈₀ | (0.043 mmol) | (6.87 mmol) | (0.017 mmol) | mL | | |
| 2 | PD₇₀-PCL₁₆- | Same as in N | 0.60 g | Same as in N | 6.31 | 8 min | 59% |
| | PD₇₀ | #1 | (6.01 mmol) | #1 | mL | | |
| 3 | PD₆₀-PCL₁₆- | Same as in N | 0.51 g | Same as in N | 5.54 | 9 min | 60% |
| | PD₆₀ | #1 | (5.15 mmol) | #1 | mL | | |
| 4 | PD₅₀-PCL₁₆- | Same as in N | 0.43 g | Same as in N | 4.77 | 9 min | 33% |
| | PD₅₀ | #1 | (4.29 mmol) | #1 | mL | | |
| 5 | PD₄₀-PCL₁₆- | Same as in N | 0.34 g | Same as in N | 4.01 | 9 min | 60% |
| | PD₄₀ | #1 | (3.44 mmol) | #1 | mL | | |
| 6 | PD₃₀-PCL₁₆- | Same as in N | 0.26 g | Same as in N | 3.24 | 9.5 min | 37% |
| | PD₃₀ | #1 | (2.58 mmol) | #1 | mL | | |
| 7 | PD₂₀-PCL₁₆- | Same as in N | 0.17 g | Same as in N | 2.48 | 14.5 min | Precipitated |
| | PD₂₀ | #1 | (1.72 mmol) | #1 | mL | | |
| 8 | PCL₂₁-PD₉₀ | 0.10 g | 0.32 g | 2.0 mg | 3.82 | 11 min | 41% |
| | | (0.036 mmol) | (3.25 mmol) | (0.007 mmol) | mL | | |
| 9 | PCL₂₁-PD₈₀ | Same as in N | 0.29 g | Same as in N | 3.50 | 12 min | 49% |
| | | #8 | (2.89 mmol) | #8 | mL | | |
| 10 | PCL₂₁-PD₇₀ | Same as in N | 0.25 g | Same as in N | 3.18 | 12 min | 37% |
| | | #8 | (2.53 mmol) | #8 | mL | | |
| 11 | PCL₂₁-PD₆₀ | Same as in N | 0.21 g | Same as in N | 2.85 | 13 min | 53% |
| | | #8 | (2.17 mmol) | #8 | mL | | |
| 12 | PCL₂₁-PD₅₀ | Same as in N | 0.18 g | Same as in N | 2.53 | 15 min | 26% |
| | | #8 | (1.81 mmol) | #8 | mL | | |
| 13 | PCL₂₁-PD₄₀ | Same as in N | 0.14 g | Same as in N | 2.21 | 16.5 min | Precipitated |
| | | #8 | (1.45 mmol) | #8 | mL | | |
| 14 | PCL₂₉-PD₁₀₀ | 0.10 g | 0.27 g | 1.5 mg | 3.34 | 10 min | 34% |
| | | (0.027 mmol) | (2.71 mmol) | (0.005 mmol) | mL | | |
| 15 | PCL₂₉-PD₉₀ | Same as in N | 0.24 g | Same as in N | 3.10 | 11 min | 45% |
| | | #14 | (2.45 mmol) | #14 | mL | | |
| 16 | PCL₂₉-PD₈₀ | Same as in N | 0.22 g | Same as in N | 2.85 | 13 min | 54% |
| | | #14 | (2.71 mmol) | #14 | mL | | |
| 17 | PCL₂₉-PD₇₀ | Same as in N | 0.19 g | Same as in N | 2.61 | 13 min | 59% |
| | | #14 | (1.90 mmol) | #14 | mL | | |
| 18 | PCL₂₉-PD₆₀ | Same as in N | 0.16 g | Same as in N | 2.37 | 14.5 min | 39% |
| | | #14 | (1.63 mmol) | #14 | mL | | |
| 19 | PCL₂₉-PD₅₀ | Same as in N | 0.13 g | Same as in N | 2.13 | 17 min | Precipitated |
| | | #14 | (1.36 mmol) | #14 | mL | | |
| 20 | PCL₄₂-PD₁₂₀ | 0.10 g | 0.23 g | 1.1 mg | 2.98 | 14 min | 60% |
| | | (0.019 mmol) | (2.32 mmol) | (0.004 mmol) | mL | | |
| 21 | PCL₄₂-PD₁₁₀ | Same as in N | 0.21 g | Same as in N | 2.81 | 10 min | 47% |
| | | #20 | (2.13 mmol) | #20 | mL | | |
| 22 | PCL₄₂-PD₁₀₀ | Same as in N | 0.19 g | Same as in N | 2.64 | 12 min | 52% |
| | | #20 | (1.94 mmol) | #20 | mL | | |
| 23 | PCL₄₂-PD₉₀ | Same as in N | 0.17 g | Same as in N | 2.46 | 13 min | 61% |
| | | #20 | (1.74 mmol) | #20 | mL | | |
| 24 | PCL₄₂-PD₈₀ | Same as in N | 0.15 g | Same as in N | 2.29 | 10 min | 29% |
| | | #20 | (1.55 mmol) | #20 | mL | | |
| 25 | PCL₄₂-PD₇₀ | Same as in N | 0.13 g | Same as in N | 2.12 | 20 min | Precipitated |
| | | #20 | (2.32 mmol) | #20 | mL | | |

TABLE 4
Summary of reagent quantities used for the initial bulk polymerization of DMAC using a TTC-PCL₁₆-TTC
precursor, with subsequent dilution to the stated final nanoparticle concentration via addition of deoxygenated
deionized water.

| | Polymer | | | | | Dilution | Intermediate |
|---|---|---|---|---|---|---|---|
| N | composition | (TTC-)PCL-TTC | DMAC | ACVA | Water | Time | conversion |
| 1 | PD₈₀-PCL₁₆- | 0.10 g | 0.68 g | 4.8 mg | 4.45 mL | 7.5 min | 31% |
| | PD₈₀ | (0.043 mmol) | (6.87 mmol) | (0.017 mmol) | | | |
| 2 | PD₈₀-PCL₁₆- | Same as in N #1 | Same as in N #1 | Same as in N #1 | 3.14 mL | 7 | 46% |
| | PD₈₀ | | | | | | |
| 3 | PD₈₀-PCL₁₆- | Same as in N #1 | Same as in N #1 | Same as in N #1 | 2.34 mL | 7.5 | 60% |
| | PD₈₀ | | | | | | |
| 4 | PD₈₀-PCL₁₆- | Same as in N #1 | Same as in N #1 | Same as in N #1 | 1.83 mL | 7.5 | 32% |
| | PD₈₀ | | | | | | |

TABLE 5
Summary of reagent quantities used for the polymerization of DMAC using either a TTC-PCL₁₆-TTC
or a PCL_{y}-TTC precursor, with subsequent dilution via addition of deoxygenated deionized water.

| | | | | | Total water | | |
|---|---|---|---|---|---|---|---|
| | Polymer | | | | (Initial | Dilution | Intermediate |
| N | composition | (TTC-)PCL-TTC | DMAC | ACVA | water) | Time | conversion |
| 1 | PD₈₀-PCL₁₆- | 0.10 g | 0.68 g | 4.8 mg | 7.07 mL | 10 min | 59% |
| | PD₈₀ | (0.043 mmol) | (6.87 mmol) | (0.017 mmol) | (0.20 mL) | | |
| 2 | PD₇₀-PCL₁₆- | Same as in N #1 | 0.60 g | Same as in N | 6.31 mL | 10 min | 59% |
| | PD₇₀ | | (6.01 mmol) | #1 | (0.18 mL) | | |
| 3 | PD₆₀-PCL₁₆- | Same as in N #1 | 0.51 g | Same as in N | 5.54 mL | 9 min | 57% |
| | PD₆₀ | | (5.15 mmol) | #1 | (0.15 mL) | | |
| 4 | PD₅₀-PCL₁₆- | Same as in N #1 | 0.43 g | Same as in N | 4.77 mL | 9 min | 52% |
| | PD₅₀ | | (4.29 mmol) | #1 | (0.13 mL) | | |
| 5 | PD₄₀-PCL₁₆- | Same as in N #1 | 0.34 g | Same as in N | 4.01 mL | 9 min | 52% |
| | PD₄₀ | | (3.44 mmol) | #1 | (0.11 mL) | | |
| 6 | PD₃₀-PCL₁₆- | Same as in N #1 | 0.26 g | Same as in N | 3.24 mL | 13 min | 60% |
| | PD₃₀ | | (2.58 mmol) | #1 | (0.09 mL) | | |
| 7 | PCL₂₁-PD₈₀ | 0.10 g | 0.29 g | 2.0 mg | 3.50 mL | 10.5 min | 34% |
| | | (0.036 mmol) | (2.89 mmol) | (0.007 mmol) | (0.10 mL) | | |
| 8 | PCL₂₉-PD₁₀₀ | 0.10 g | 0.27 g | 1.5 mg | 3.34 mL | 12 min | 45% |
| | | (0.027 mmol) | (2.71 mmol) | (0.005 mmol) | (0.09 mL) | | |
| 9 | PCL₄₂-PD₁₂₀ | 0.10 g | 0.23 g | 1.1 mg | 2.98 mL | 7 min | 21% |
| | | (0.019 mmol) | (2.32 mmol) | (0.004 mmol) | (0.08 mL) | | |

### Preparation of Azoxystrobin Suspension Concentrates by Ball Milling

Azoxystrobin (2.00 g), PDMACₓ-PCL₁₆-PDMACₓ nanoparticles (0.25 g, 10% w/w), SAG1572 antifoam (0.10 g, 1.0% w/w) and deionized water (7.65 g) were added to a 30 mL sample tube containing 1.0 mm ceramic beads (10.0 g). This aqueous suspension was then ball-milled using an IKA Ultra-Turrax Tube Drive at 6 000 rpm for 30 min. The beads were removed by filtration to afford a 20% w/w aqueous suspension of azoxystrobin microparticles. This suspension was purified by centrifugation for 10 min at 13 000 rpm using a Thermo Heraeus Biofuge Pico centrifuge. The aqueous supernatant was decanted and the sedimented azoxystrobin microparticles were redispersed in deionized water. Two further centrifugation-redispersion cycles were performed to remove any excess non-adsorbed triblock copolymer nanoparticles prior to characterization by optical microscopy, laser diffraction and TEM.

### Characterization Techniques

### ¹H NMR Spectroscopy

Spectra were obtained using a 400 MHz Bruker Avance-400 spectrometer operating at 298 K with 16 scans being averaged per spectrum. Samples were dissolved in CD₂Cl₂ and aqueous dispersions of the copolymer were dried with anhydrous magnesium sulfate before passing through a 0.20 μm filter. DMAC conversions were calculated by comparing the integrated vinyl proton signals at 6.63, 6.23 and 5.66 ppm against the PCL signal at 4.1 ppm.

### GPC

The number-average molecular weight (Mₙ), weight-average molecular weight (M_{w}) and dispersity (M_{w}/Mₙ) was determined for each (co)polymer using an Agilent 1260 Infinity GPC system equipped with a differential refractive index detector and a UV detector set at 305 nm. Two Agilent PL-gel 5 m Mixed-C columns and a guard column were connected in series to this GPC system. Unless otherwise stated, the GPC eluent was high-performance liquid chromatography (HPLC) grade DMF containing 10 mM LiBr. GPC analysis was performed at 60° C. using a constant flow rate of 1.0 mL min⁻¹. A series of twelve near-monodisperse poly(methyl methacrylate) calibration standards with Mₚ values ranging from 800 g mol⁻¹ to 2 200 000 g mol⁻¹ was used to calculate molecular weights and dispersities. All (co)polymer samples were diluted to 1.0% w/w using the GPC eluent and chromatograms were analyzed using Agilent GPC/SEC software.

### DLS

Unless stated otherwise, experiments were conducted at 20° C. using a Malvern Instruments Zetasizer Nano ZS instrument equipped with a 4 mW He—Ne laser (λ=633 nm) and an avalanche photodiode detector. Scattered light was detected at 173°. Aqueous block copolymer dispersions were diluted to 1.0% w/w with deionized water prior to analysis. Five minutes was allowed for thermal equilibration at the beginning of each measurement. The mean z-average particle diameter (D₂) and polydispersity index (PDI) were averaged over three consecutive runs consisting often measurements each.

For analysis of the degradation of PCL-based nanoparticles, DLS measurements were performed directly on the 1% w/w degradation solution. The mean number-average particle diameter (Dₙ) and count rate were averaged over three consecutive runs consisting of ten measurements each.

### TEM

Copper/palladium grids (Agar Scientific, UK) were coated in-house with a thin film of amorphous carbon and then treated with a plasma glow discharge for 30 seconds to generate a hydrophilic surface. A 10 μL droplet of freshly diluted 1.0% w/w aqueous copolymer dispersion was placed on a hydrophilic grid for 1 min, then blotted to remove excess sample. Each grid was negatively stained for a further 25 seconds using a 10 μL droplet of 0.75% w/v aqueous uranyl formate solution, which was then carefully blotted to remove excess stain. Each grid was dried with the aid of a vacuum hose. Imaging was performed using a FEI Tecnai Spirit 2 microscope equipped with an Orius SC1000B camera operating at 80 kV.

### Laser Diffraction

The initial azoxystrobin crystals and the ball-milled azoxystrobin microparticles were analyzed by laser diffraction using a Malvern Mastersizer 3000 instrument equipped with a Hydro EV wet dispersion unit set at 1500 rpm. Samples were allowed to equilibrate for ten minutes before measurements. The volume-average particle diameter, d(0.5), was calculated by averaging over three measurements with an assumed absorption index of 0.10.

### Optical Microscopy

A PC-controlled Cole-Palmer optical microscope equipped with a Moticam camera was used for imaging both the original coarse azoxystrobin crystals and the azoxystrobin microparticles obtained after wet ball-milling.

### Aqueous Electrophoresis

A Malvern Instruments Zetasizer Nano ZS instrument was used to characterize copolymer dispersions diluted to 0.1% w/w using 1 mM KCl as background electrolyte. Mobilities were determined at 20° C. and the solution pH was adjusted using either 0.1 M NaOH or 0.1 M HCl as required. Zeta potentials were calculated from the Henry equation using the Smoluchowski approximation.

### Differential Scanning Calorimetry

Measurements were performed using a TA DSC25 Discovery series instrument operating from −90 to 100° C. at a rate of 10° C. min⁻¹ using aluminum T_{zero} pans and standard lids. Instrument calibration was performed using an indium standard. All DSC analyses involved three heating/cooling cycles.

### Shear-induced Polarized Light Imaging

Shear alignment experiments were conducted using a mechano-optical rheometer (Anton Paar Physica MCR301 with SIPLI attachment). Measurements were performed using a plate-plate geometry composed of a 25 mm polished steel plate and a fused quartz plate connected to a variable temperature Peltier system. The gap between plates was set at 0.50 mm for all experiments. An additional Peltier hood was used to ensure good control of the sample temperature. Sample illumination was achieved using an Edmund Optics 150 W MI-150 high-intensity fiber-optic white light source. The polarizer and analyzer axes were crossed at 90° to obtain polarized light images, which were recorded using a color CCD camera (Lumenera Lu165c)

What we claim is:

1. A polymer having the structure 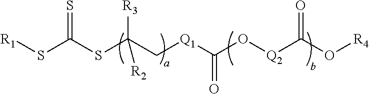
wherein R₄ is a C₁-C₄₀ functionalized or unfunctionalized hydrocarbyl moiety or 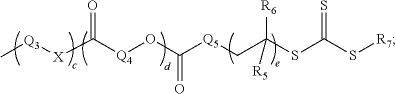
each R₁ and R₇ is independently a C₁-C₁₁ functionalized or unfunctionalized hydrocarbyl moiety; each R₂ and R₅ is independently hydrogen or methyl; each R₃ and R₆ is independently a C₁-C₄₀ functionalized or unfunctionalized hydrocarbyl moiety; each X is independently oxygen or NR₈; each R₈ is independently hydrogen or C₁-C₅ alkyl; each Q₁ and Q₅ is independently a C₁-C₁₀ functionalized or unfunctionalized hydrocarbylene moiety; each Q₂ and Q₄ is independently a C₃-C₈ functionalized or unfunctionalized alkylene moiety; each Q₃ is independently a functionalized or unfunctionalized hydrocarbylene moiety; and each a, b, d, and e independently ranges from about 5 to about 200, and c ranges from 1 to about 100.

2. The polymer according to claim 1 having the structure 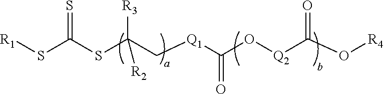
wherein R₁ is a C₁-C₁₁ functionalized or unfunctionalized hydrocarbyl moiety; each R₂ is independently hydrogen or methyl; each R₃ is independently a C₁-C₄₀ functionalized or unfunctionalized hydrocarbyl moiety; R₄ is a C₁-C₄₀ functionalized or unfunctionalized hydrocarbyl moiety; Q₁ is a C₁-C₁₀ functionalized or unfunctionalized hydrocarbylene moiety; each Q₂ is independently a C₃-C₈ functionalized or unfunctionalized alkylene moiety; and each a and b ranges from about 5 to about 200.

3. The polymer according to claim 1 having the structure 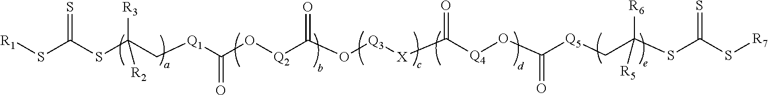
wherein each R₁ and R₇ is independently a C₁-C₁₁ functionalized or unfunctionalized hydrocarbyl moiety; each R₂ and R₅ is independently hydrogen or methyl; each R₃ and R₆ is independently a C₁-C₄₀ functionalized or unfunctionalized hydrocarbyl moiety, each X is independently oxygen or NR₈; each R₈ is independently hydrogen or C₁-C₅ alkyl; each Q₁ and Q₅ is independently a C₁-C₁₀ functionalized or unfunctionalized hydrocarbylene moiety; each Q₂ and Q₄ is independently a C₃-C₈ functionalized or unfunctionalized alkylene moiety; each Q₃ is independently a functionalized or unfunctionalized hydrocarbylene moiety; and each a, b, d, and e independently ranges from about 5 to about 200, and c ranges from 1 to about 100.

4. The polymer according to claim 2 wherein said Q₂ is a propylene, butylene, pentamethylene, or hexamethylene moiety.

5. The polymer according to claim 3 wherein each said Q₂ and Q₄ is a propylene, butylene, pentamethylene, or hexamethylene moiety.

6. The polymer according to claim 3 wherein said Q₃ is ethylene, propylene, or butylene moiety and said X is oxygen.

7. The polymer according to claim 2 wherein said a ranges from about 10 to about 150 and said b ranges from about 10 to 50.

8. The polymer according to claim 3 wherein each said a and e ranges from about 10 to about 150 and each said b and d ranges from about 10 to 50.

9. The polymer according to claim 8 wherein said a and e are identical and said b and d are identical.

10. The polymer according to claim 3 wherein each said R₁ and R₇ is a C₁-C₅ alkyl.

11. The polymer according to claim 10 wherein said R₁ and R₇ are identical.

12. The polymer according to claim 2 wherein said Q₁ is a C₁-C₅ functionalized or unfunctionalized hydrocarbylene moiety.

13. The polymer according to claim 3 wherein each said Q₁ and Q₅ is a C₁-C₅ functionalized or unfunctionalized hydrocarbylene moiety.

14. The polymer according to claim 3 wherein said c ranges from 1 to about 10.

15. The polymer according to claim 2 or 3 wherein each said R₈ is independently a functionalized or unfunctionalized C₁-C₁₀ hydrocarbyl moiety.

16. The polymer according to claim 2 wherein each said R₃ is independently selected from the group consisting of 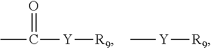
R₉, and combinations thereof, wherein each R₉ is independently a functionalized or unfunctionalized C₁-C₄₀ hydrocarbyl moiety, each Y is independently oxygen, sulfur, or NR₁₀, and each R₁₀ is independently hydrogen or C₁-C₅ alkyl.

17. The polymer according to claim 3 wherein each said R₃ and R₆ is independently selected from the group consisting of 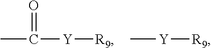
R₉, and combinations thereof, wherein each R₉ is independently a functionalized or unfunctionalized C₁-C₄₀ hydrocarbyl moiety, each Y is independently oxygen, sulfur, or NR₁₀, and each R₁₀ is independently hydrogen or C₁-C₅ alkyl.

18. The polymer according to claim 16 or 17 wherein each said R₉ is independently selected from the group consisting of methyl, ethyl, isopropyl, n-butyl, isobutyl, sec-butyl, n-pentyl, 2-hydroxyethyl, 2-pyrrolidonylethyl, cyclohexyl, and combinations thereof.

19. The polymer according to claim 2 wherein said R₄ is a C₁-C₁₀ functionalized or unfunctionalized hydrocarbyl moiety.

20. The polymer according to claim 2 having a structure selected from the group consisting of 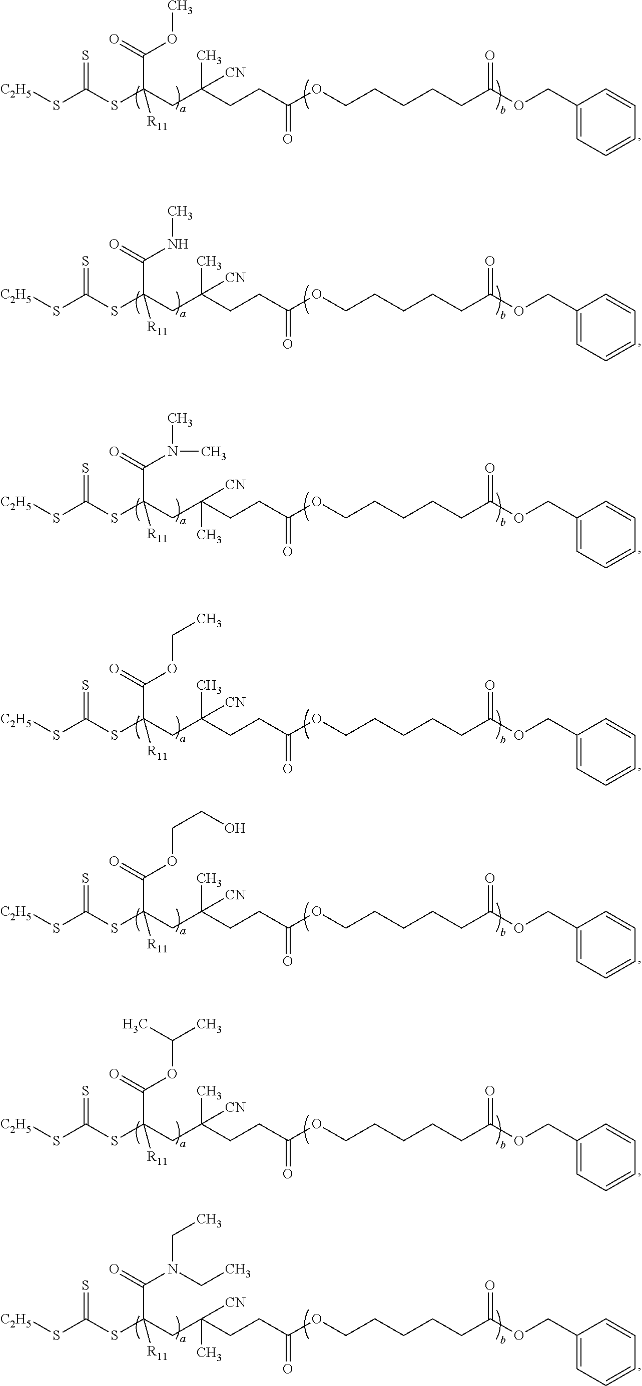 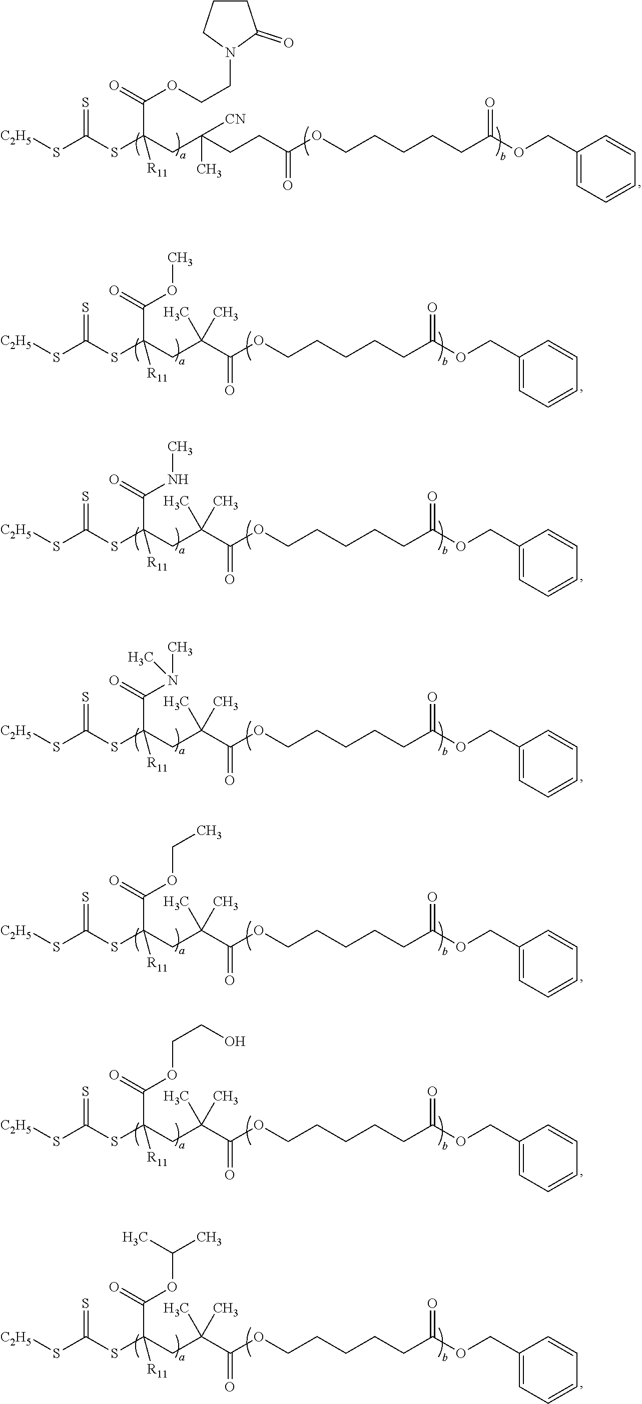 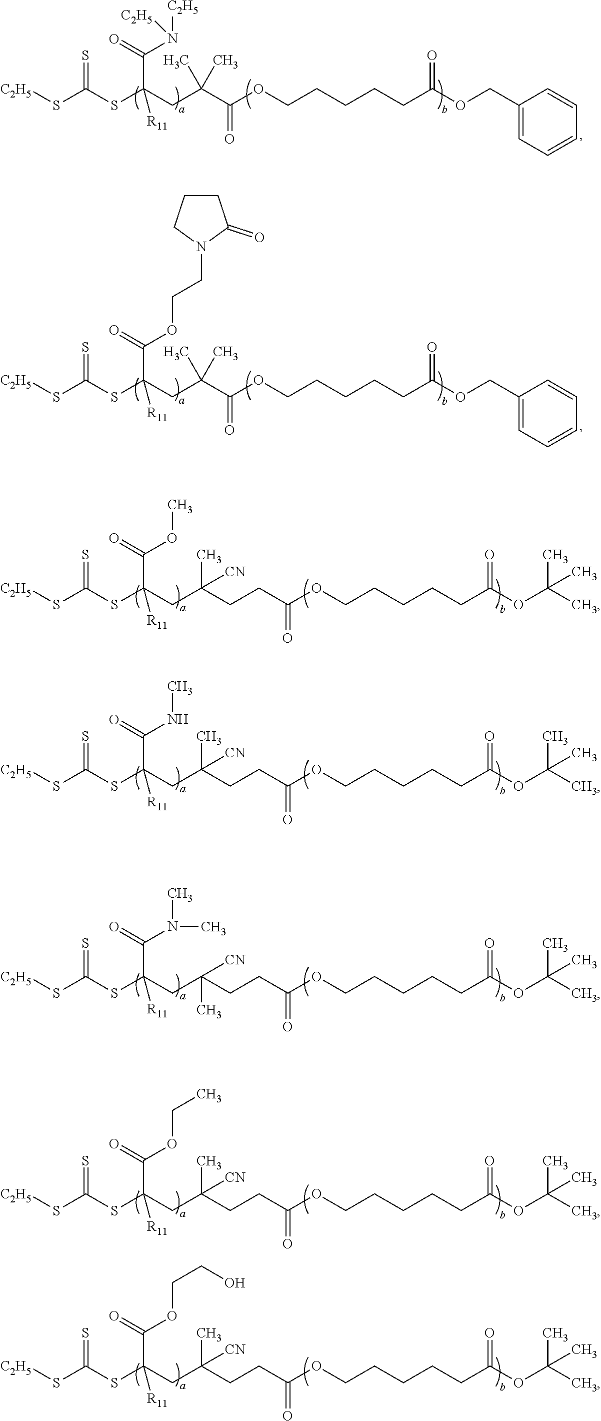 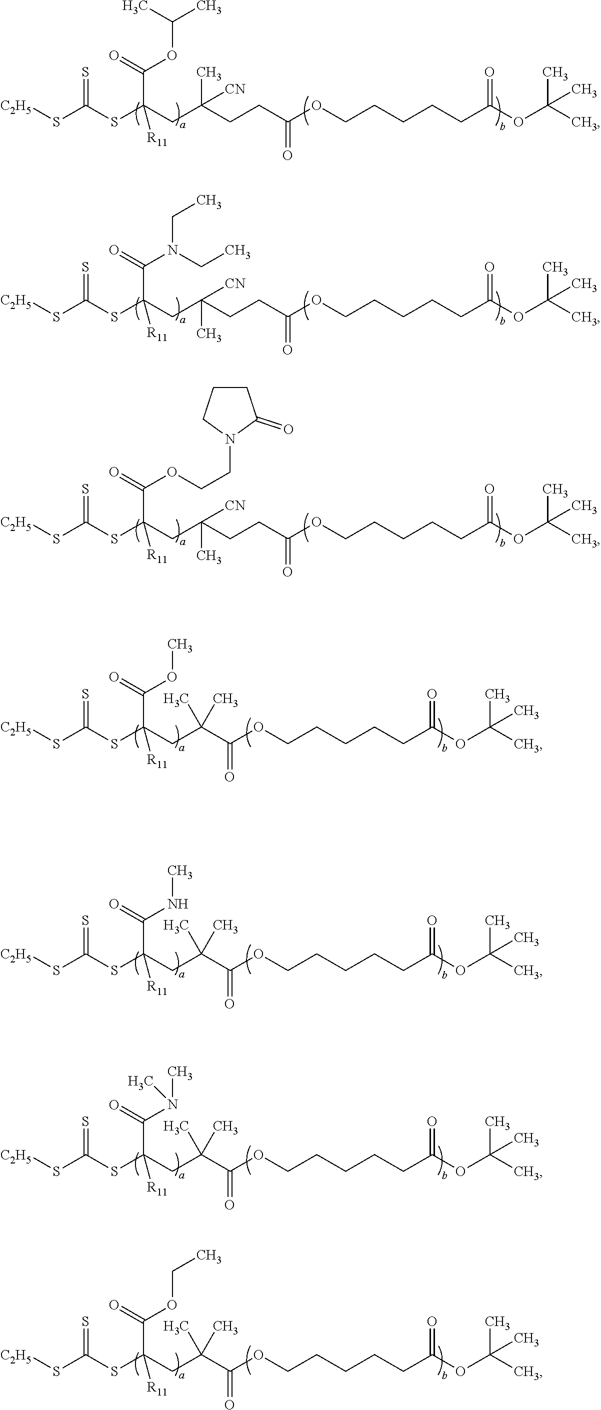 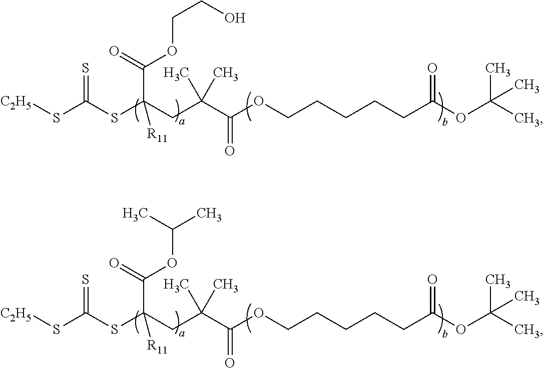 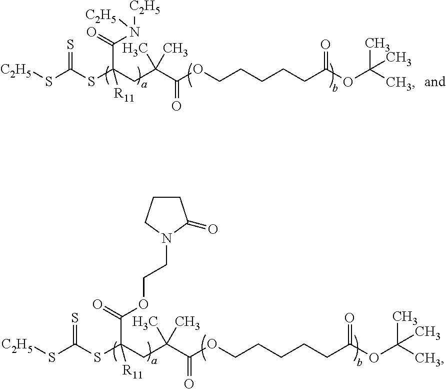
wherein a ranges from about 10 to about 150, b ranges from about 10 to 50, and each R₁ is independently selected from the group consisting of hydrogen, methyl, and combinations thereof.

21. The polymer according to claim 3 having a structure selected from the group consisting of 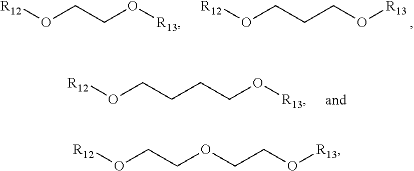
wherein each R₁₂ and R₁₃ is independently selected from the group consisting of 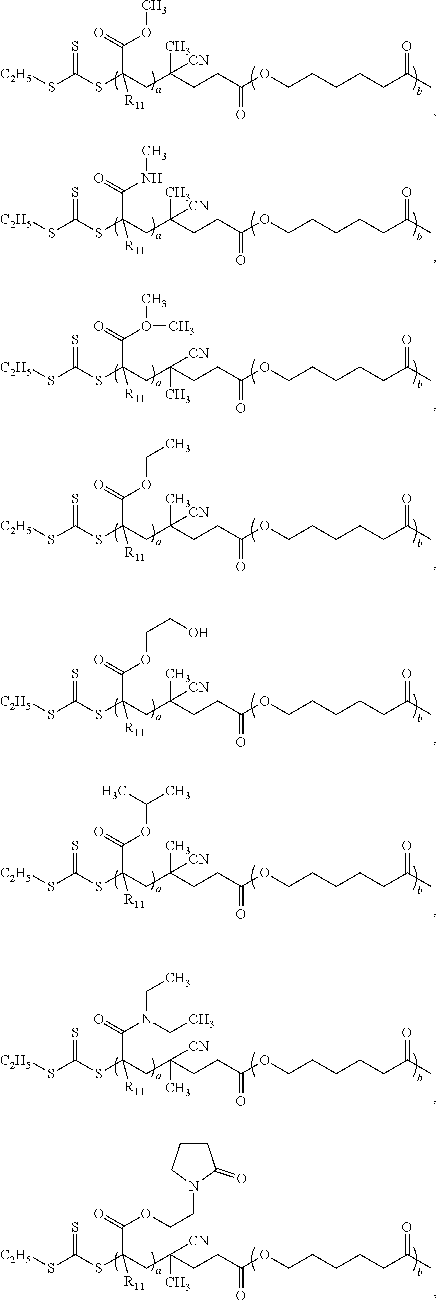 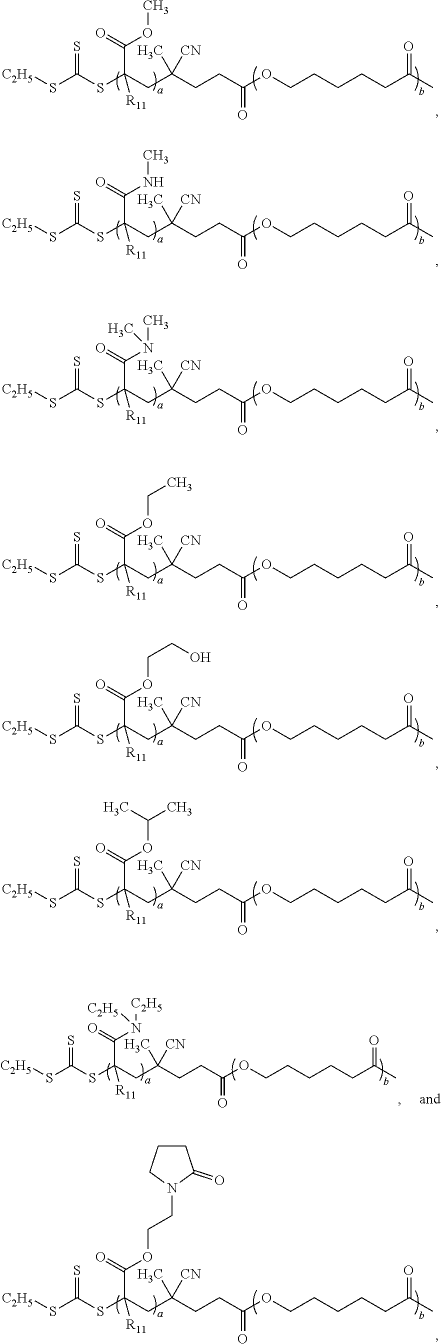
wherein a ranges from about 10 to about 150, b ranges from about 10 to 50, and each R₁ is independently selected from the group consisting of hydrogen, methyl, and combinations thereof.

22. The polymer according to claim 21 wherein said R₁₂ and R₁₃ are identical.

23. A composition comprising a polymer having the structure 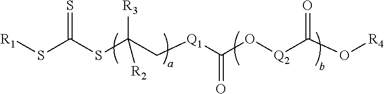
wherein R₄ is a C₁-C₄₀ functionalized or unfunctionalized hydrocarbyl moiety or 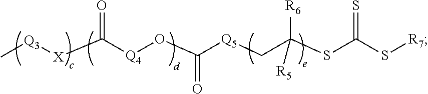
each R₁ and R₇ is independently a C₁-C₁₁ functionalized or unfunctionalized hydrocarbyl moiety; each R₂ and R₅ is independently hydrogen or methyl; each R₃ and R₆ is independently a C₁-C₄₀ functionalized or unfunctionalized hydrocarbyl moiety; each X is independently oxygen or NR₈; each R₈ is independently hydrogen or C₁-C₅ alkyl; each Q₁ and Q₅ is independently a C₁-C₁₀ functionalized or unfunctionalized hydrocarbylene moiety; each Q₂ and Q₄ is independently a C₃-C₈ functionalized or unfunctionalized alkylene moiety; each Q₃ is independently a functionalized or unfunctionalized hydrocarbylene moiety; and each a, b, d, and e independently ranges from about 5 to about 200, and c ranges from 1 to about 100.

24. The composition according to claim 23 wherein said polymer has the structure 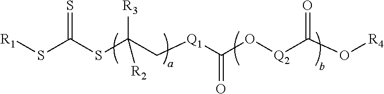
wherein R₁ is a C₁-C₁₁ functionalized or unfunctionalized hydrocarbyl moiety; each R₂ is independently hydrogen or methyl; each R₃ is independently a C₁-C₄₀ functionalized or unfunctionalized hydrocarbyl moiety; R₄ is a C₁-C₄₀ functionalized or unfunctionalized hydrocarbyl moiety; Q₁ is a C₁-C₁₀ functionalized or unfunctionalized hydrocarbylene moiety; each Q₂ is independently a C₃-C₈ functionalized or unfunctionalized alkylene moiety; and each a and b ranges from about 5 to about 200.

25. The composition according to claim 23 wherein said polymer has the structure 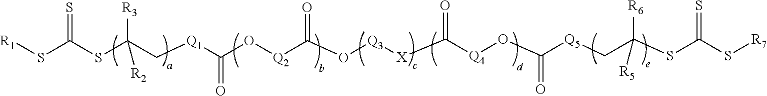
wherein each R₁ and R₇ is independently a C₁-C₁₁ functionalized or unfunctionalized hydrocarbyl moiety; each R₂ and R₅ is independently hydrogen or methyl; each R₃ and R₆ is independently a C₁-C₄₀ functionalized or unfunctionalized hydrocarbyl moiety, each X is independently oxygen or NR₈; each R₈ is independently hydrogen or C₁-C₅ alkyl; each Q₁ and Q₅ is independently a C₁-C₁₀ functionalized or unfunctionalized hydrocarbylene moiety; each Q₂ and Q₄ is independently a C₃-C₈ functionalized or unfunctionalized alkylene moiety; each Q₃ is independently a functionalized or unfunctionalized hydrocarbylene moiety; and each a, b, d, and e independently ranges from about 5 to about 200, and c ranges from 1 to about 100.

26. The composition according to claim 24 wherein said Q₂ is a propylene, butylene, pentamethylene, or hexamethylene moiety.

27. The composition according to claim 25 wherein each said Q₂ and Q₄ is a propylene, butylene, pentamethylene, or hexamethylene moiety.

28. The polymer according to claim 25 wherein said Q₃ is ethylene, propylene, or butylene moiety and said X is oxygen.

29. The composition according to claim 25 wherein each said R₁ and R₇ is a C₁-C₅ alkyl.

30. The composition according to claim 24 wherein each said R₃ is independently selected from the group consisting of 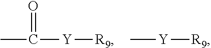
R₉, and combinations thereof, wherein each R₉ is independently a functionalized or unfunctionalized C₁-C₄₀ hydrocarbyl moiety, each Y is independently oxygen, sulfur, or NR₁₀, and each R₁₀ is independently hydrogen or C₁-C₅ alkyl.

31. The composition according to claim 25 wherein each said R₃ and R₆ is independently selected from the group consisting of 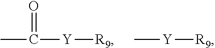
R₉, and combinations thereof, wherein each R₉ is independently a functionalized or unfunctionalized C₁-C₄₀ hydrocarbyl moiety, each Y is independently oxygen, sulfur, or NR₁₀, and each R₁₀ is independently hydrogen or C₁-C₅ alkyl.

32. The composition according to claim 30 or 31 wherein each said R₉ is independently selected from the group consisting of methyl, ethyl, isopropyl, n-butyl, isobutyl, sec-butyl, n-pentyl, 2-hydroxyethyl, 2-pyrrolidonylethyl, cyclohexyl, and combinations thereof.

33. The composition according to claim 24 wherein said polymer has a structure selected from the group consisting of 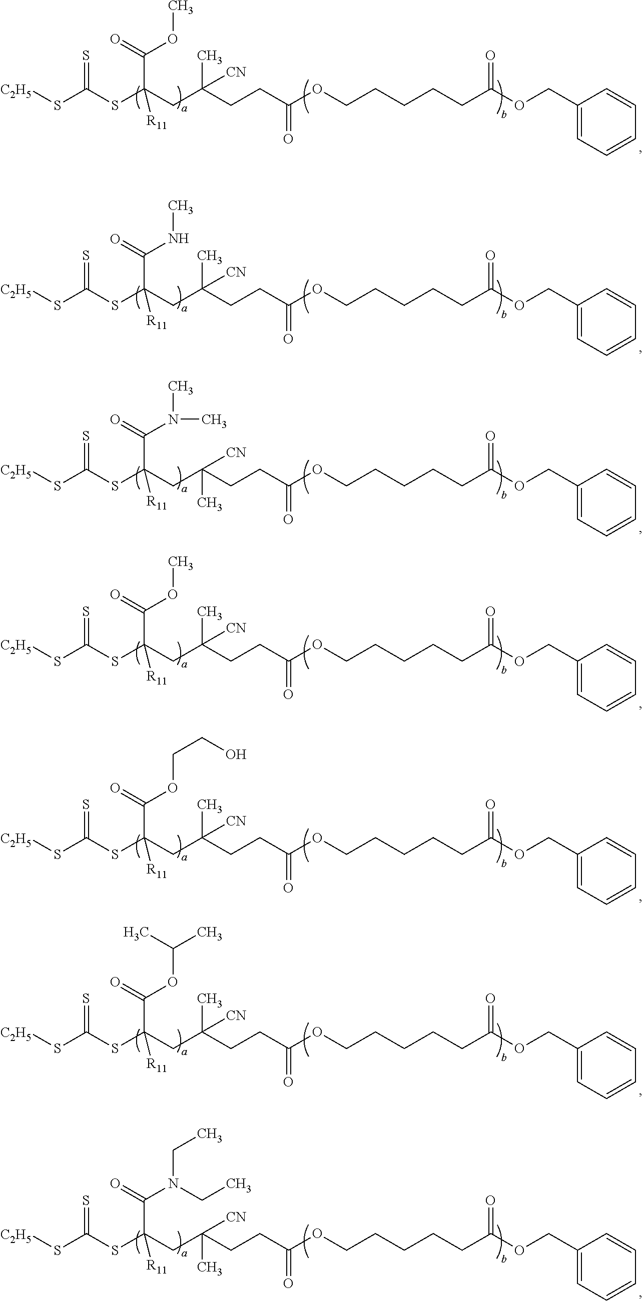 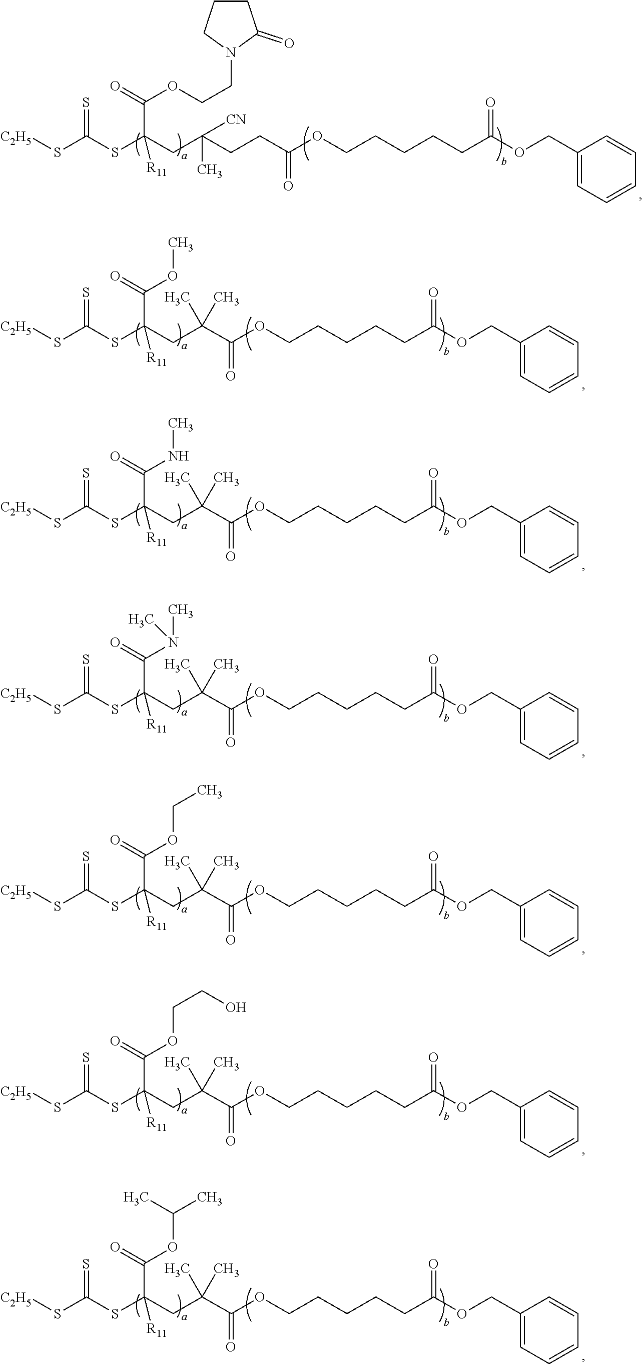 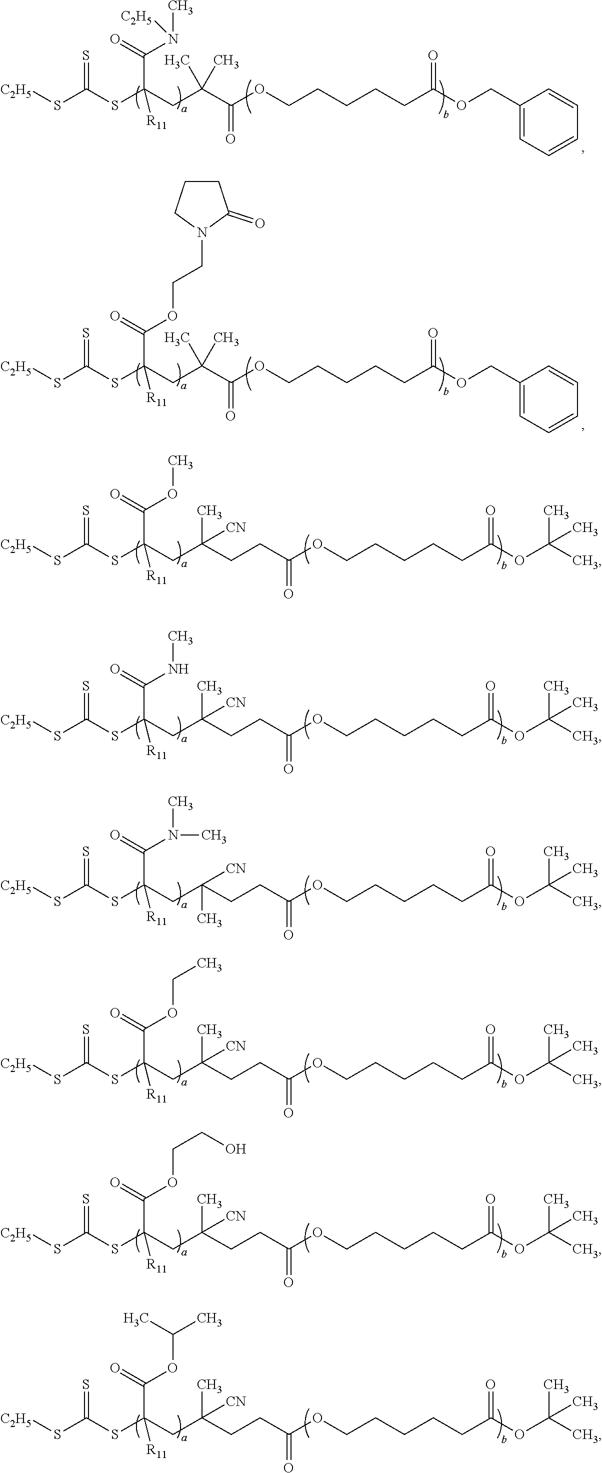 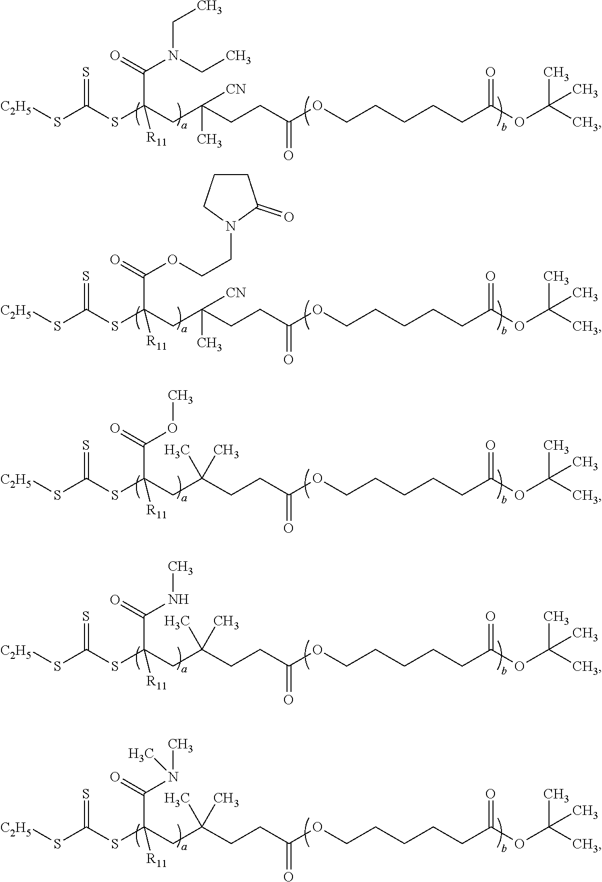 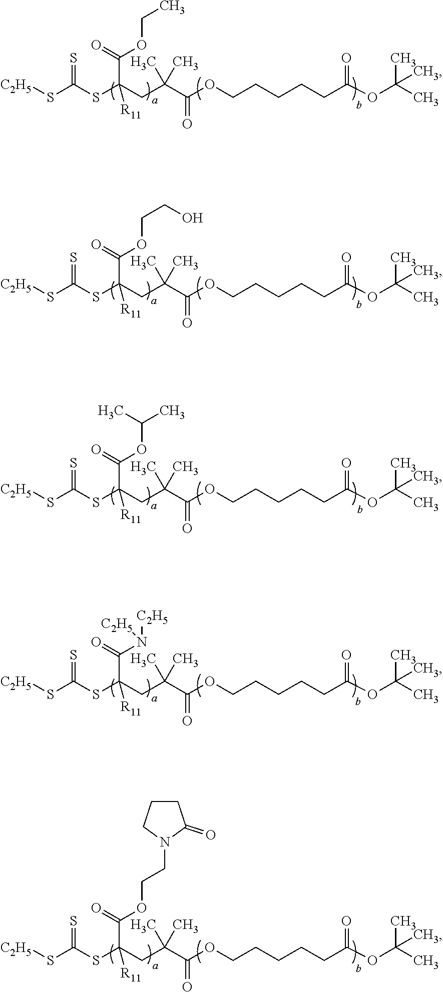
wherein a ranges from about 10 to about 150, b ranges from about 10 to 50, and each R₁ is independently selected from the group consisting of hydrogen, methyl, and combinations thereof.

34. The composition according to claim 25 wherein said polymer has a structure selected from the group consisting of 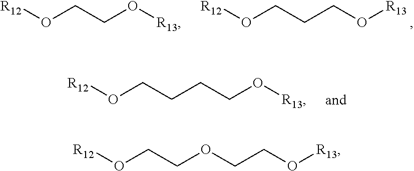
wherein each R₁₂ and R₁₃ is independently selected from the group consisting of 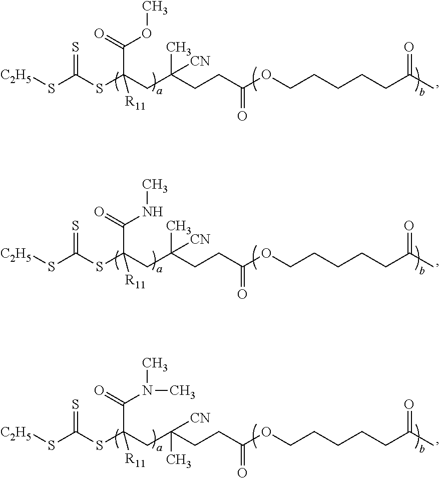 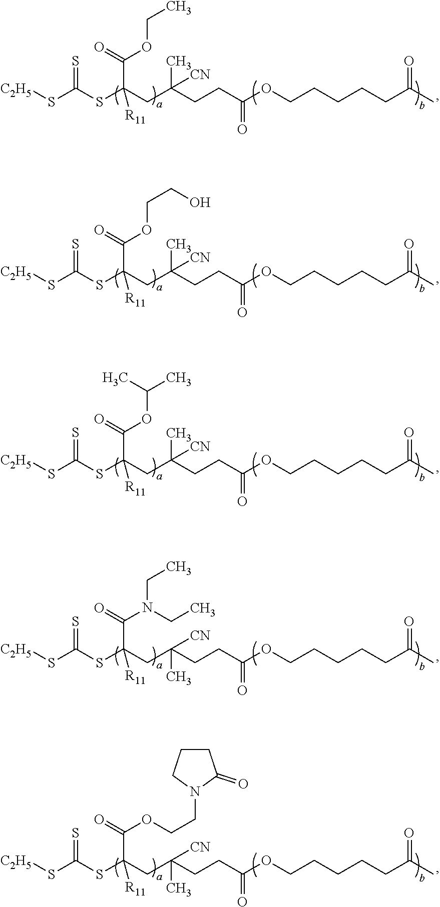 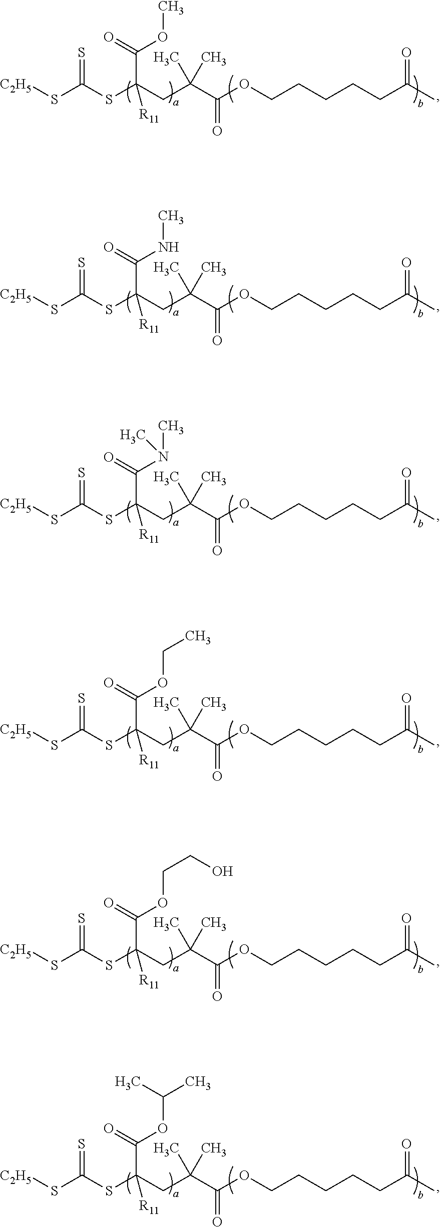 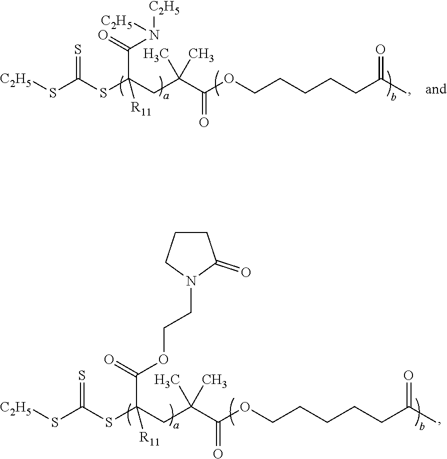
wherein a ranges from about 10 to about 150, b ranges from about 10 to 50, and each Rn is independently selected from the group consisting of hydrogen, methyl, and combinations thereof.

35. The composition according to claim 23, 24, or 25 that is in the form of colloidal particles.

36. The composition according to claim 35 wherein said particles are spherical in shape.

37. The composition according to claim 36 wherein said particles have an average diameter ranging from about 1 to about 1000 nanometer.

38. The composition according to claim 37 wherein said particles have an average diameter ranging from about 5 to about 100 nanometer.

39. The composition according to claim 23, 24, or 25 that is an agrochemical composition, pharmaceutical composition, medical composition, biotechnological composition, pesticide composition, personal care composition, coating composition, construction composition, nutritional composition, adhesive composition, oilfield composition, household, industrial and institutional composition, thermoplastic composition, cementing fluid, servicing fluid, gravel packing mud, fracturing fluid, completion fluid, work-over fluid, spacer fluid, drilling mud, biocide, ink, paper, polish, membrane, metal working fluid, plastic, textile, printing composition, lubricant, detergent, battery composition, glass coating composition, or preservative composition.

40. The composition according to claim 39 further comprising at least one additive selected from the group consisting of solubilizers, binders, lubricants, surfactants, oils, waxes, solvents, emulsifiers, preservatives, antioxidants, antiradical protecting agents, vitamins, perfumes, insect repellants, dyes, pigments, humectants, fillers, thickeners, film formers, stabilizers, buffers, spreading agents, electrolytes, acids, bases, structuring agents, abrasives, and combinations thereof.

41. A method for reducing particle size of at least one active ingredient comprising: (a) contacting to form a mixture, said active ingredient in a solid form and a colloidal composition comprising a polymer having the structure 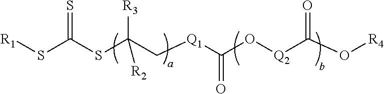
wherein R₄ is a C₁-C₄₀ functionalized or unfunctionalized hydrocarbyl moiety or 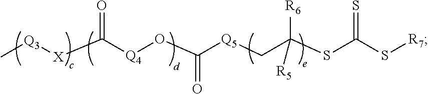
each R₁ and R₇ is independently a C₁-C₁₁ functionalized or unfunctionalized hydrocarbyl moiety; each R₂ and R₅ is independently hydrogen or methyl; each R₃ and R₆ is independently a C₁-C₄₀ functionalized or unfunctionalized hydrocarbyl moiety; each X is independently oxygen or NR₈; each R₈ is independently hydrogen or C₁-C₅ alkyl; each Q₁ and Q₅ is independently a C₁-C₁₀ functionalized or unfunctionalized hydrocarbylene moiety; each Q₂ and Q₄ is independently a C₃-C₈ functionalized or unfunctionalized alkylene moiety; each Q₃ is independently a functionalized or unfunctionalized hydrocarbylene moiety; and each a, b, d, and e independently ranges from about 5 to about 200, and c ranges from 1 to about 100; and (b) subjecting said mixture to at least one particle size reduction operation.

42. The method for reducing particle size of at least one active ingredient according to claim 41 wherein said active ingredient is selected from the group consisting of an agrochemical active ingredient, a pesticidal active ingredient, a pharmaceutical active ingredient, a medical active ingredient, a biotechnological active ingredient, or combinations thereof.

43. The method for reducing particle size of at least one active ingredient according to claim 41 wherein said colloidal composition comprises spherical colloidal particles of said polymer.

44. The method for reducing particle size of at least one active ingredient according to claim 43 wherein said spherical colloidal particles have an average diameter ranging from about 1 to about 1000 nanometer.

45. The method for reducing particle size of at least one active ingredient according to claim 44 wherein said spherical colloidal particles have an average diameter ranging from about 5 to about 100 nanometer.

46. The method for reducing particle size of at least one active ingredient according to claim 41 wherein said solid form is selected from the group consisting of crystalline form, semicrystalline form, polymorphous form, amorphous form, cocrystal form, and combinations thereof.

47. The method for reducing particle size of at least one active ingredient according to claim 41 wherein said particle size reduction operation is ball milling.
